(19) United States
(12) Patent Application Publication
(10) Pub. No.: US 2006/0041401 A1
(43) Pub. Date: Feb. 23, 2006

(54) Methods, systems, and computer program products for facilitating user choices among complex alternatives using conjoint analysis in combination with psychological tests, skills tests, and configuration software

(76) Inventor: Jeffrey M. Johnston, Durham, NC (US)

Correspondence Address: JENKINS, WILSON & TAYLOR, P. A., 3100 TOWER BLVD, SUITE 1400, DURHAM, NC, 27707, US

(21) Appl. No.: 11/203,670

(22) Filed: Aug. 12, 2005

Related U.S. Application Data
(60) Provisional application No. 60/601,187, filed on Aug. 12, 2004.

(51) Int. Cl. G06F 15/00

(52) U.S. Cl. 702/186

(57) ABSTRACT

Methods, systems, and computer program products for facilitating user choices among complex alternatives utilize conjoint analysis in combination with psychological tests, skills tests, or configuration software to simplify choices to be made by the user. A selector tool presents a user with a first and second series of choices relating to attributes of complex alternatives available to the user. A utilities calculation engine calculates the relative utility of each of the complex alternatives to the user and presents output to the user, which indicates the relative utility of each of the complex alternatives. The user can then select the complex alternative that has the highest utility value for the user based on the calculated relative utility values. Configuration software, psychological tests, and/or skills tests or personality tests may be used before or after the conjoint analysis to facilitate user choices among complex alternatives by selecting attributes used for the conjoint analysis and/or selecting among results of the conjoint analysis.

### RELATED APPLICATIONS

This application is related to U.S. patent application Ser. No. 09/704,349, filed Nov. 1, 2000 (now U.S. Pat. No. 6,826,541, issued on Nov. 30, 2004), the disclosure of which is incorporated herein by reference in its entirety.

This application claims the benefit of U.S. provisional patent application No. 60/601,187, filed on Aug. 12, 2004, the disclosure of which is incorporated herein by reference in its entirety.

### TECHNICAL FIELD

The subject matter described herein relates to using a proven social science statistical technique called conjoint analysis to facilitate choices among complex alternatives. More particularly, the subject matter described herein relates to methods, systems and computer program products for facilitating individual user choices among complex alternatives using conjoint analysis in combination with psychological tests, skills tests, and configuration software.

### BACKGROUND ART

As a research methodology, conjoint analysis has been in use in the academic and commercial research community for many years (since the mid-1970's), and has been commonly used for marketing research purposes to assess consumer preferences among competing products or services.

Generally, conjoint analysis is a tool that researchers use to estimate the relative importance of the attributes that comprise the “alternatives” in the “choice set” and how much utility each “setting” of each “attribute” has for individuals. Results are often used to simulate the effect on market share that various changes in the “attribute settings” have and thus to fine tune “alternatives” (e.g. identify the optimal price for a product) and to forecast market share. While many forms of conjoint analysis exist, there are two general defining properties of any conjoint process: 1) each at some point gathers data from individuals by asking each individual to consider (the “con” in conjoint) two or more variables simultaneously or jointly (the “joint” in conjoint) and 2) each uses the gathered data (responses) to estimate how much utility or value each “attribute setting.” Typically, conjoint data is gathered from a sample of users and then analyzed with no flow of information back to the user. Thus, there exists a long-felt need for applications that use conjoint analysis to facilitate individual user choices among complex decisions by providing conjoint analysis results back to the individual user.

In addition to conjoint analysis, psychological tests, skills tests, and configuration software are further examples of decision-making tools. For example, psychological tests, such as personality tests are used in on-line dating services to match individuals with potential mates. Skills tests are used by employees to evaluate the proficiency with which potential employee can perform a job-related task. Configuration software presents a user with product features, allows the user to select desirable features, and presents available products that match the user's configuration. While conjoint analysis, psychological tests, skills tests, and configuration software have been used individually to facilitate user choices among complex alternatives, there is no known method or system that combines conjoint analysis with psychological tests, skills tests, or configuration software. Accordingly, there exists a long-felt need for improved methods and systems for facilitating user selection among complex alternatives using conjoint analysis in combination with psychological tests, skills tests, and configuration software.

### SUMMARY

According to one aspect, the subject matter described herein includes a software tool that embodies a “conjoint” model decision process permitting the simplification of difficult choices among complex alternatives into a sequence of short, simpler decisions. “Alternatives” in this context can be products (such as automobiles), services (such as health plans), combinations of complementary services and products, product components, physical characteristics of potential dating partners, skills test results of potential employee, or virtually anything else individuals must decide to choose or not choose. Complex “alternatives” are those defined in terms of many “variables” such that in the decision process a lot of information must be considered. Complex “alternatives” often create difficult decisions that demand that the chooser trade-off the good and bad in each “alternative.” For example, the choice between a high-quality bicycle and a low-quality bicycle, given quality is the only criterion used in the selection, is an easy one. However, as the alternatives become more complex, the choice becomes more difficult and trade-offs must be made. The choice between a high-quality, $500 bicycle that comes in pink only versus a low-quality, $100 bicycle that comes in either green, black, or blue is a more difficult decision than that based on quality only.

The subject matter described herein uses, at its core, an adaptation of the conjoint model decision process. The use of the conjoint exercise allows to the tool to assist users in making difficult decisions less complex. By going through the exercise, unique profiles of what is important to the user are developed by the application.

In addition to developing user profiles, the subject matter described herein, at the end of the exercise, provides users with a “quality of fit” measure of how well each product, service, or other selection available to them meets their unique profile.

In order to facilitate user choices among complex alternatives, one exemplary implementation of the subject matter described herein includes computer software that requires an individual user to go through a series of less complex choices. The software first presents the user with a list of features. The user selects features that are of importance to the user. The software then presents the user with a first series of choices requiring the user to input or select first values indicating the relative importance of a best setting and a worst setting of each of the selected features. The user is then presented with a second series of choices requiring the user to input or select second values indicating the relative importance of the user's preference between first and second pairings of the selected attributes. Each pairing includes a best setting of one attribute and a worst setting of another attribute. The values input by the user in the second series of choices are interpreted as the mathematical difference equal to the relative importance of a best and worst setting of one attribute minus the relative importance of a best and a worst setting for the other attribute in the pairing. A final importance value is calculated for each of the attributes based on the initial relative importance values in the first series of choices and the mathematical difference values. Products, services, or other selections available to the user are rated based on the final importance values. The user is then presented with data indicating the relative utility to the user of each of the products, services, or other selections.

Conjoint analysis may be combined with psychological or skills tests in any number of ways. For example, psychological or skills test results may be used to limit the attributes presented to an individual in the conjoint analysis. In an alternate implementation, psychological or skills test results may be used to select among the products or services after the products or services have been rated using conjoint analysis.

Conjoint analysis may similarly be combined with configuration software in any number of ways. For example, configuration software may be executed by a user. The results of the execution may be used to limit the attributes that are presented to the user in the conjoint analysis. In an alternate implementation, conjoint analysis may be performed first and the results may be used to limit the product configurations made available to the user by the configuration software.

### Terminology

Before proceeding, a review of keywords and key phrases and their definitions used in this document is warranted. These keywords are placed in double quotes throughout the document to indicate their use may be somewhat different from common use.

| Keyword or | |
|---|---|
| Key Phrase | Definition |
| “user” | A person going through the software exercise |
| | to gain help in making a choice |
| “alternative” | A single product, service, or other selection |
| | (among a set of products or services) the |
| | “user” can potentially choose |
| “choice set” | All the “alternatives” the “user” is eligible to |
| | choose from |
| “attribute” | One of numerous variables, each defined as |
| | the continuum between its worst “setting” and |
| | best “setting,” used to define the “alternatives” |
| “setting” (or | The value a particular hypothetical or actual |
| “attribute setting”) | “alternative” has for a particular “attribute”; the |
| | hypothetical “alternatives” studied during the |
| | data-gathering phase of the algorithm are all |
| | specified in terms of the worst “setting” vs. the |
| | best “setting” for each “attribute,” whereas |
| | actual “alternatives” available to the “user” |
| | may be specified by “settings” anywhere |
| | along each “attribute's” continuum |
| “importance” | A measure that the user gives directly via the |
| | importance-of-the-difference (between worst |
| | and best “settings”) screens of the relative |
| | importance of a single “attribute” |
| “difference in | A measure that the user gives directly via the |
| importance” | trade-off screens of the (mathematical) |
| | difference in the “importance” of two |
| | “attributes” |
| “final computed | A final estimate of the true relative importance |
| importance” | of an “attribute” to a “user” |
| “setting utility” | The relative (relative to all “attribute settings”) |
| (or “attribute | worth or utility of a particular “attribute setting” |
| setting utility”) | (anywhere along the “attribute” continuum) to |
| | a particular “user” |
| “total utility” | The total relative (relative to all “alternatives” |
| | available to that user) worth or utility of a |
| | particular “alternative”; defined as the simple |
| | sum across “attributes” of the “setting utilities” |

To ensure these keywords and phases are understood, the following example is given.

A person is trying to make a choice between a medium-quality bicycle priced at $250 and a high-quality bicycle priced at $375. The person is given a tool that assists the person in the selection. The tool requires the person to state on a 1-to-5 scale the relative importance of quality and price. For purposes of this example, it is assumed that the person selects 5 and 4, respectively. The values “5” and “4” are “importance” measures as defined above. The tool also asks the person to rate to what degree the person would prefer a high-quality, $500 bicycle to a low-quality, $100 bicycle. In this example, it is assumed that the person indicates a preference for the higher quality, more expensive bicycle, a “+1” on a −4-to-+4 scale. The value +1 is a “difference in importance” value as defined above. The tool then computes that the true importance (on a 1-to-5 scale) of quality and price for this person is a 4.7 and a 4.1, respectively. The values 4.7 and 4.1 are “final computed importance” values, as defined above. These values are used in turn to compute that high quality is worth 25 (unitless) points to the person whereas medium quality is worth 15 points. The values “15” and “25” are “setting utilities” for the quality and price attributes. Similarly, the tool computes that $250 is worth 15 points to the person and $375 is worth 10. Thus, the tool computes that the total worth of the medium-quality bicycle priced at $250 is 30 points (15+15) and that the total worth of the high-quality bicycle priced at $375 is 35 points (25+10). The 30 and 35-point values are “total utility” values as defined above. Because 35 is higher than 30, the tool has computed that the medium-quality bicycle priced at $250 is worth slightly less to the person, all things considered, than the high-quality bicycle priced at $375. Thus, the tool recommends that the person should choose the high-quality bicycle priced at $375. The following table provides a summary of examples of each keyword or key phrase from the above example.

| Keyword or | |
|---|---|
| Key Phrase | Example |
| “user” | The person shopping for a bicycle |
| “alternative” | The medium-quality bicycle priced at $250 |
| | and the high-quality bicycle priced at $375 are |
| | the actual “alternatives”; the high-quality, $500 |
| | bicycle and the low-quality, $100 bicycle are |
| | the hypothetical “alternatives” used in the |
| | data-gathering phase |
| “choice set” | The medium-quality bicycle priced at $250 |
| | and the high-quality bicycle priced at $375 |
| | together form the actual choice set for the |
| | “user”; the high-quality, $500 bicycle and the |
| | low-quality, $100 bicycle form a hypothetical |
| | “choice set” to which the “user” is asked to |
| | react. |
| “attribute” | Quality is an “attribute” as is price |
| “setting” | $375 is an actual “setting” of price; $100 is a |
| (or “attribute setting”) | hypothetical “setting” for price |
| “importance” | The “5” given for quality |
| “difference in | The “+1” |
| importance” | |
| “final computed | The “4.7” for quality |
| importance” | |
| “setting utility” | The “25” for the high-quality “setting” of quality |
| (or “attribute | |
| setting utility”) | |
| “total utility” | The “30” for the medium-quality bicycle priced |
| | at $250 “alternative” |

The subject matter described herein may achieve one or more of the following goals. First, create an adaptation of conjoint that is as user friendly as possible (keep it short and easy to understand). Second, go beyond the end of traditional conjoint (developing “utilities”) and apply these utilities to the performance of a set of products, presenting the user with a sorted list of how well each product meets their stated preferences. In adapting a research statistical technique, traditionally used to study group preferences, and using it to match individual consumer preferences to actual products, services, or other selections implementations of the subject matter described herein can be highly useful in the marketplace.

As mentioned above, conjoint has been in use since the 1970's. While there are a variety of implementations of the conjoint algorithm in the market, the design chosen for implementation of the subject matter described herein is exceptionally simple, and yet robust. For example, features of real products are evaluated and levels are created, so that all products can be compared by the application in a purely objective basis. The feature attribute descriptions are made as simple and as straightforward as possible. In addition, after the user completes the process of selecting attributes features of the product or other selection, making importance of difference decisions, and then trade-off decisions, the application presents results to the user in very simple bar-chart form. The application shows all products or other selections available to the user in priority order, based on how well each product or other selections matches the preference utility of that individual.

The algorithm utilized by implementations of the subject matter described herein provides for paired trade-offs (two by two comparisons of end-point “attribute” characteristics) instead of the usual more complicated trade-offs involving more than two “attributes” defined not only by their end-points (best and worst “settings”), but by numerous “settings” along their entire continuum. As used herein, the term “endpoints” refers to the best and worst settings of an attribute. For example, in the bicycle example discussed above, $100 and $500 are endpoints for the price attribute; whereas “high” and “low” are endpoints for the quality attribute.

According to one implementation of the subject matter described herein, an “X” matrix utilized to estimate “attribute” “utilities”. An “X matrix”, as described herein, is a configuration of explanatory variable data, or numbers, in a mathematical format. The “X matrix” designates the independent variable values used in the ordinary least squares matrix set, whereas the “Y Matrix” designates the dependent variable values. Examples of X and Y matrices and their use in calculating utilities for attributes will be discussed in more detail below.

Yet another aspect of implementations of the subject matter described herein is the way in which the results of a user's interaction with the tool are “fed back” to the user. For example, each individual's alternative choices of products, services or concepts are ranked in declining order of “total utility.” This way of “reporting” back to each user on how their priorities and decision criteria “value” each alternative clearly indicate the “best fit” choices among all the alternatives in an individual's “choice set.”

While one use of conjoint analysis as described herein is an attribute, preference-based decision support tool, the software also simultaneously creates databases of user-level “preference data” (i.e. “final computed importance” and “setting utility” data) and other descriptive data. This data has value in the marketplace to producers and middleman organizations as conjoint research and can be used for developing analyses of market share “attribute” importance, and other outcomes of the decision-making process. The creation and merchandizing of this data is very much a fundamental aspect of the tool's value.

### BRIEF DESCRIPTION OF THE DRAWINGS

Preferred embodiments of the subject matter described herein will now be explained with reference to the accompanying drawings, of which:

FIG. 1 is a block diagram illustrating an exemplary operating environment for embodiments of the subject matter described herein;

FIG. 2 is a block diagram of a selector tool server suitable for use with embodiments of the subject matter described herein;

FIG. 3 is a block diagram illustrating the relationship between screens presented to the user by the selector tool server according to an embodiment of the subject matter described herein;

FIGS. 4A and 4B are examples of attribute selection page 302 illustrated in FIG. 3;

FIGS. 5A and 5B are examples of importance page 304 illustrated in FIG. 3;

FIGS. 6A and 6B are examples of paired trade-off page 306 illustrated in FIG. 3;

FIGS. 7A and 7B are examples of results page 308 illustrated in FIG. 3;

FIGS. 8A and 8B are examples of details page 310 illustrated in FIG. 3;

FIG. 9 is a block diagram of a layered selector tool server suitable for use with embodiments of the subject matter described herein;

FIG. 10 is a flow chart illustrating an exemplary process for combining conjoint analysis with a psychological test according to an embodiment of the subject matter described herein;

FIG. 11 is a flow chart of an exemplary process for combining conjoint analysis with configuration software according to an embodiment of the subject matter described herein; and

FIG. 12 is a flow chart of an exemplary process for combining conjoint analysis with configuration software according to an alternate embodiment of the subject matter described herein.

### DETAILED DESCRIPTION

### Overview

An automated conjoint analysis engine suitable for use with embodiments of the subject matter described herein may include three main steps followed by results and detailed comparisons. Each of these steps through the exercise is interactive—that is, each step engages the “user” and requires the “user's” input. In addition, each step relies on the previous step. How the “user” responds in one step will affect what the user is asked to do in subsequent steps. At the end of these steps the user is provided with results.

The main components of the tool are:
1. “Attribute” Selection—branded on the site displayed as “Attribute Selection”
2. “Importance” Ratings—branded on the site displayed as “Importance of Difference”
3. “Difference in Importance” Ratings—branded on the site displayed as “Trade-Offs”
4. Results
5. Detailed “Alternative” Comparisons

Software for implementing each of these steps will be discussed in more detail below following a discussion of the operating environment for the software.

### Exemplary Operating Environment

Turning to the drawings, wherein like reference numerals refer to like elements, the subject matter described herein is illustrated as being implemented in a suitable computing environment. Although not required, the present subject matter will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the subject matter described herein may be practiced with other computer system configurations, including hand-held devices, multi-processor systems, microprocessor based or programmable consumer electronics, network PCs, minicomputers, mainframe computers, and the like. The subject matter described herein may also be practiced in distributed computing environments where tasks are performed by remote processing devices that are linked through a communications network. In a distributed computing environment, program modules may be located in both local and remote memory storage devices.

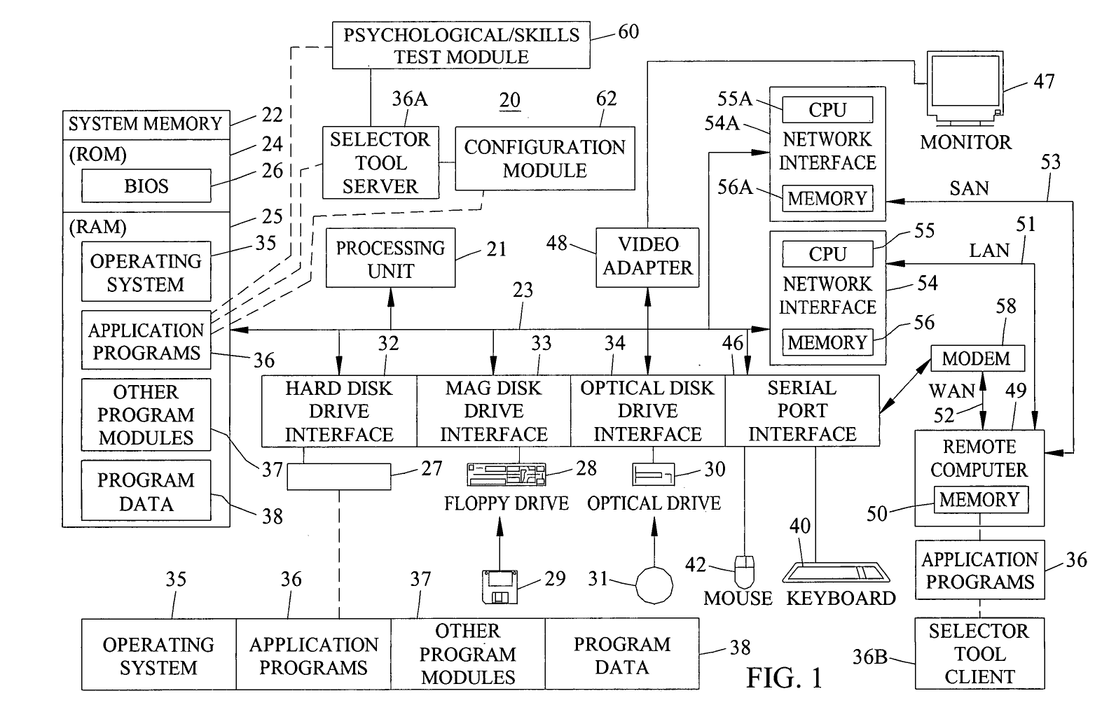

With reference to FIG. 1, an exemplary system for implementing the subject matter described herein includes a general purpose computing device in the form of a conventional personal computer 20, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help to transfer information between elements within the personal computer 20, such as during start-up, is stored in ROM 24. The personal computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer readable instructions, data structures, program modules and other data for the personal computer 20. Although the exemplary environment described herein employs a hard disk, a removable magnetic disk 29, and a removable optical disk 31, it will be appreciated by those skilled in the art that other types of computer readable media which can store data that is accessible by a computer, such as magnetic cassettes, flash memory cards, digital video disks, Bernoulli cartridges, random access memories, read only memories, and the like may also be used in the exemplary operating environment.

A number of program modules may be stored on the hard disk, magnetic disk 29, optical disk 31, ROM 24 or RAM 25, including an operating system 35, one or more applications programs 36, other program modules 37, and program data 38.

A user may enter commands and information into the personal computer 20 through input devices such as a keyboard 40 and a pointing device 42. Other input devices (not shown) may include a microphone, touch panel, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB). A monitor 47 or other type of display device is also connected to the system bus 23 via an interface, such as a video adapter 48. In addition to the monitor, personal computers typically include other peripheral output devices, not shown, such as speakers and printers. With regard to the subject matter described herein, the user may use one of the input devices to input data indicating the user's preference between alternatives presented to the user via monitor 47.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51, a wide area network (WAN) 52, and a system area network (SAN) 53. Local- and wide-area networking environments are commonplace in offices, enterprise-wide computer networks, intranets and the Internet.

When used in a LAN or SAN networking environment, the personal computer 20 is connected to the local network 51 or system network 53 through the network interface adapters 54 and 54A. The network interface adapters 54 and 54A may include processing units 55 and 55A and one or more memory units 56 and 56A.

When used in a WAN networking environment, the personal computer 20 typically includes a modem 58 or other means for establishing communications over the WAN 52. The modem 58, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

In the description that follows, the present subject matter will be described with reference to acts and symbolic representations of operations that are performed by one or more computers, unless indicated otherwise. As such, it will be understood that such acts and operations, which are at times referred to as being computer-executed, include the manipulation by the processing unit of the computer and/or the processing units of I/O devices of electrical signals representing data in a structured form. This manipulation transforms the data or maintains it at locations in the memory system of the computer and/or the memory systems of I/O devices, which reconfigures or otherwise alters the operation of the computer and/or the I/O devices in a manner well understood by those skilled in the art. The data structures where data is maintained are physical locations of the memory that have particular properties defined by the format of the data. However, while the subject matter described herein is being described in the foregoing context, it is not meant to be limiting as those of skill in the art will appreciate that the acts and operations described hereinafter may also be implemented in hardware.

In FIG. 1, exemplary application programs 36 used to implement the present subject matter include a selector tool server 36A implemented on local computer 20 and a selector tool client 36B implemented on remote computer 49. Selector tool server 36A may communicate with selector tool client 36B over local area network 51, system area network 53, or wide area network 52. Exemplary communication protocols that may be used for communication between selector tool server 36A and selector tool client 36B over LAN 51 or SAN 53 include HTTP over TCP/IP. Exemplary communication protocols that may be used to communicate between selector tool server 36A and selector tool client 36B over WAN 52 include the point-to-point protocol (PPP).

Selector tool server 36A preferably performs the functions of presenting the user with a series of choices relating to complex alternatives, calculating relative utility scores of the alternatives based on the choices, and feeding back to the user an indication of which of the complex alternatives has the highest utility for that user. A psychological/skills test module 60 may administer psychological and/or skills tests to a user and use the results of the tests to limit or select alternatives presented to a user via selector tool server 36A in performing a conjoint analysis. In an alternate implementation, psychological/skills test module 60 may administer psychological and/or skills tests to a user and the results may be used to limit or select product, service, or other choices output by selector tool server 31A that are presented to a user.

In a similar manner, configuration module 62 may allow a user to select components of a product or service. The user selection may be used to limit or select attributes presented to the user via selector tool server 36A. In an alternate implementation, configuration module 62 may operate on output from selector tool server 36A to limit or select product, service, or other choices presented to a user after conjoint analysis. Selector tool client 36B may establish a connection with selector tool server 36A in order to provide communications between the user and selector tool server 36A. In a preferred embodiment, selector tool client 36B comprises a web browser, such as Internet Explorer available from Microsoft Corporation of Redmond, Wash., or Netscape Navigator available from America Online Corporation of Reston, Va.

The subject matter described herein is not limited to a selector tool that is implemented as a selector tool server and a selector tool client connected via a network. For example, in an alternative embodiment, the subject matter described herein may be implemented entirely on a local machine wherein the selector tool comprises an application program that presents the user with a series of choices relating to complex alternatives, calculates the relative utility of the complex alternatives, and feeds the relative utility information back to the user entirely on the local machine. However, a networked environment is preferred so that multiple users can access the selector tool server. For example, for an on-line dating application that combines personality tests with conjoint analysis, selector tool server 36A may be resident on a server accessible by users. In this manner, users may access selector tool server 36A using a web browser that is common on most personal computers. Users can store and manage their own attribute information via their respective web browsers. Personality/skills tests module 60 may administer personality tests to users seeking dating partners. The personality test results may be used to limit attributes or results presented to the users during the conjoint analysis.

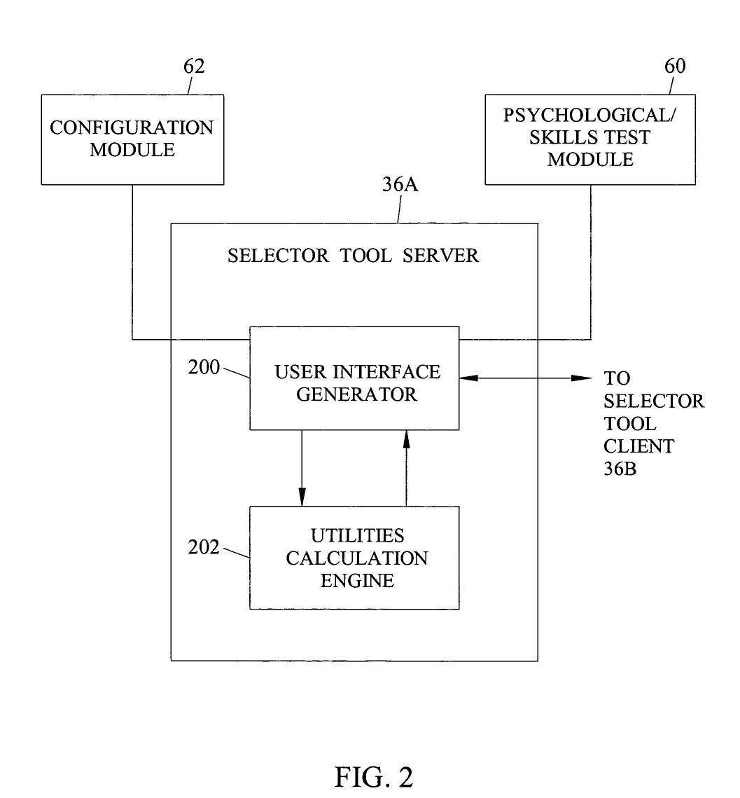

FIG. 2 is a block diagram of selector tool server 36A psychological/skills test module 60, and configuration module 62. In the illustrated embodiment, selector tool server 36A includes a user interface generator 200 and a utilities calculation engine 202. User interface generator 200 may be a web server. User interface generator 200 preferably presents a series of input screens to the user relating to choices between complex alternatives. User interface generator 200 also receives input from the user and delivers that input to utilities calculation engine 202. Utilities calculation engine 202 calculates a total relative utility value for each of the complex alternatives, based on the user choices. Utilities calculation engine 202 outputs the total utilities calculations to user interface generator 200. User interface generator 200 then outputs the total utilities values to selector tool client 36B.

Psychological/skills test module 60 may control attributes presented to the user via user interface generator 200 or output presented to the user after calculation by utilities calculation engine 202. Similarly, configuration module 62 may control attributes presented to the user based on the results of product configurations available to the user and/or output presented to the user by user interface generator via utilities calculation engine 200.

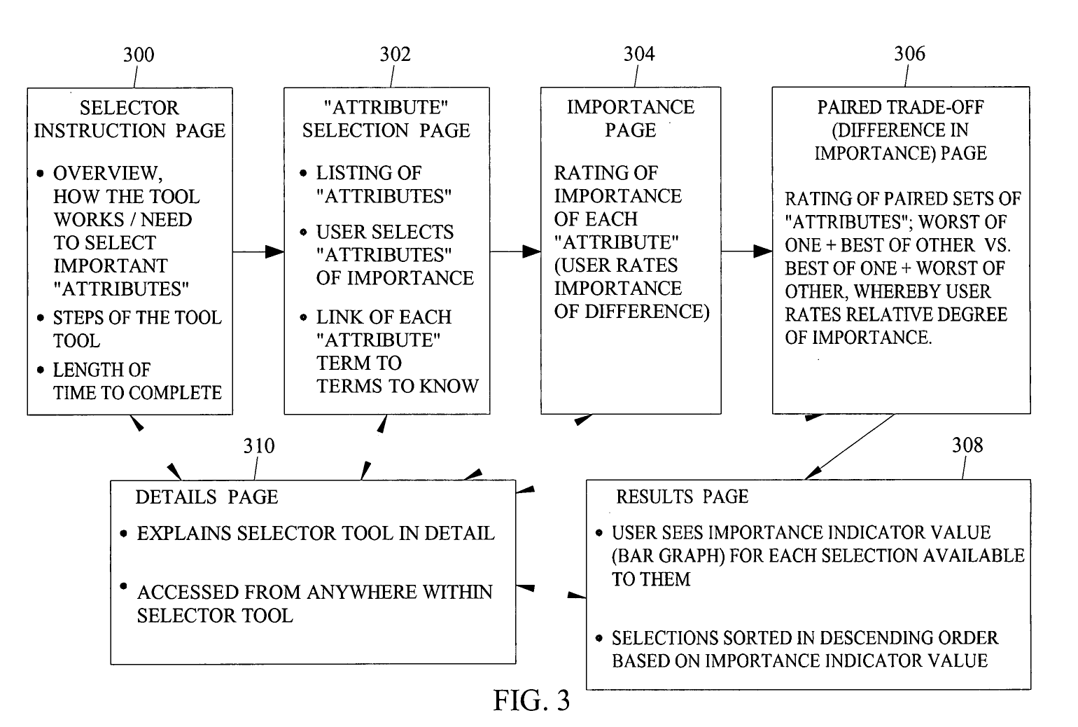

FIG. 3 is a block diagram of exemplary screens that may be presented by user interface generator 200 illustrated in FIG. 2. The screens illustrated in FIG. 3 are generic and can be used to apply conjoint analysis to facilitate user choices between any complex alternatives, including potential dating partners, potential employees, and complex products. In FIG. 3, selector tool instruction page 300 provides an overview of how the selector tools works, steps required to be performed by the user in using the tool, and the length of time required to complete the selection. Because selector tool instruction page 300 does not provide functionality important to describing the present subject matter, further description relating thereto will not be presented herein.

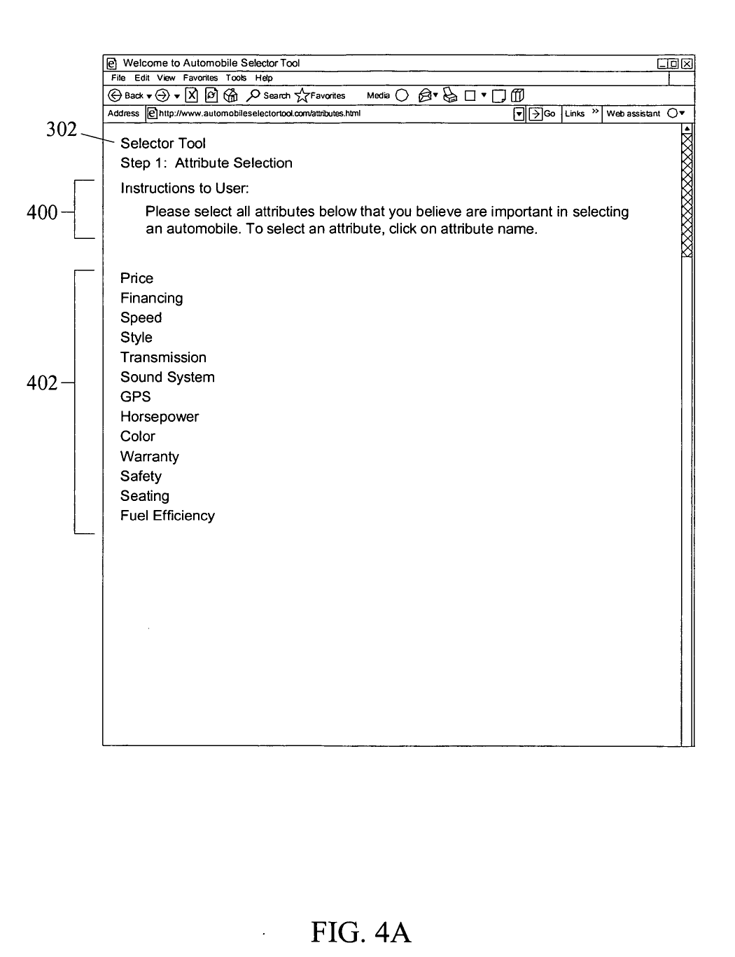

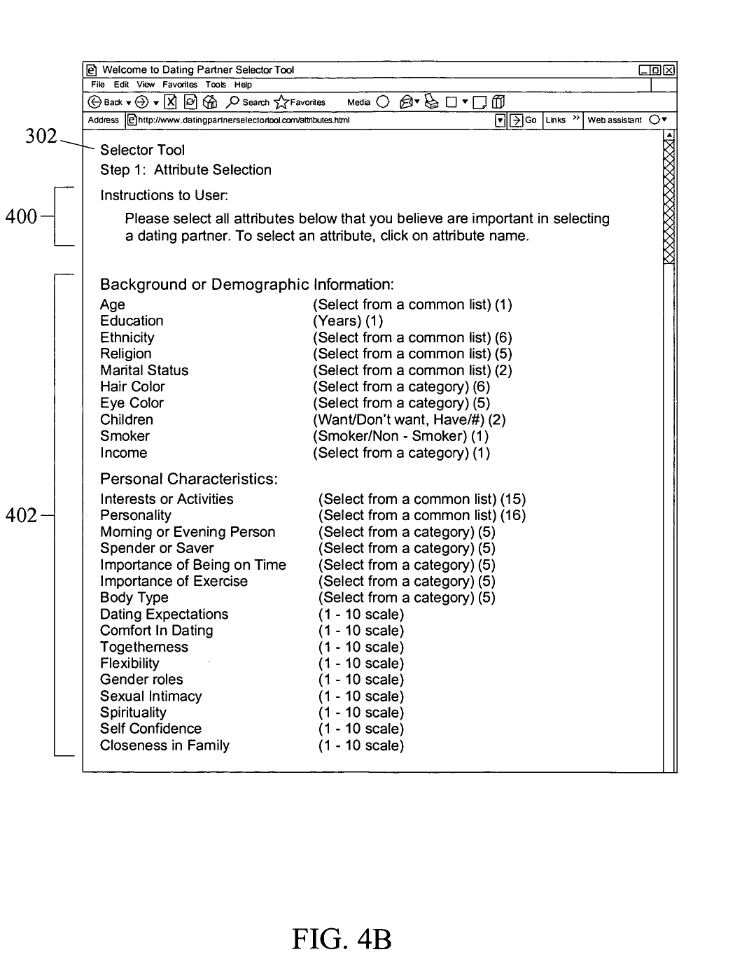

Attribute selection page 302 provides a listing of attributes, allows the user to select attributes that are of importance to the user, and links each attribute to terms to know. FIG. 4A is an example of attribute selection page 302. In FIG. 4A, attribute selection page 302 includes attributes that may be used in selecting an automobile in the embodiment of the subject matter described herein where conjoint analysis is combined with product configuration software. In the illustrated example, attribute selection page 302 includes an instruction section 400. Instruction section 400 includes instructions that instruct the user to select all attributes that the user believes to be important in selecting an automobile. Attribute selection section 402 includes a list of attributes relating to automobiles. In order to select an attribute, the user may click on the appropriate attribute name. Clicking on the appropriate attribute name may send the attribute selection to the selector tool server.

FIG. 4B illustrates an example of attribute selection page 302 where the attributes presented relate to combining conjoint analysis with personality tests for an online dating service. In FIG. 4B, the attributes in attribute selection section 402 correspond to attributes of potential dating partners. The user can select attributes that are most important to the user in selecting a potential dating partner. The attributes will be communicated to the selector tool server and used to formulate subsequent questions to the user, as will be described in detail below.

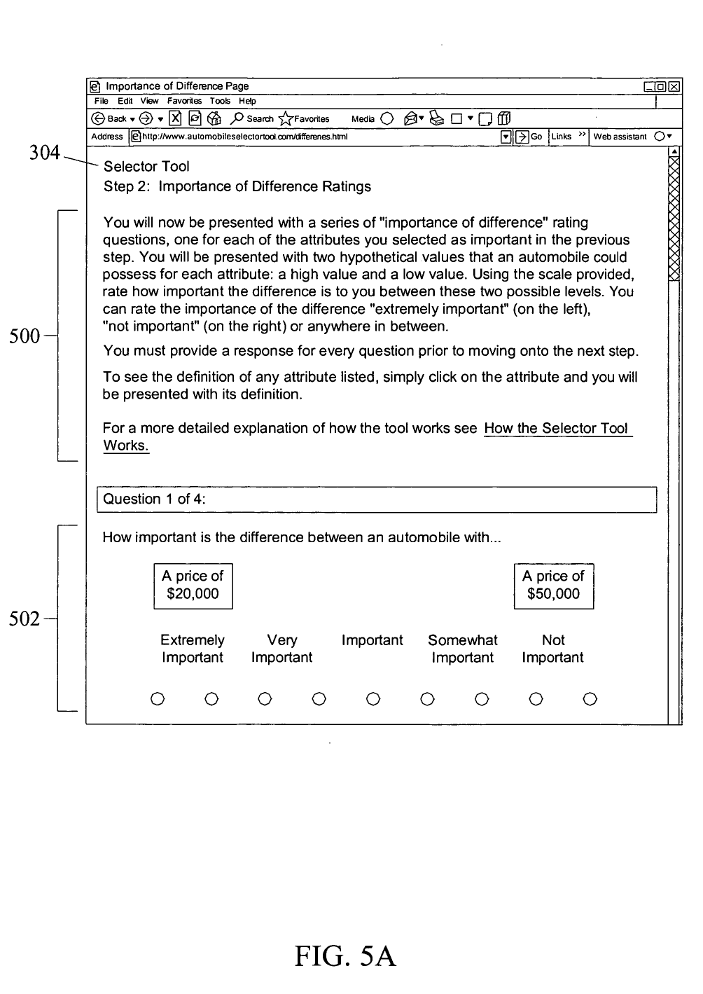

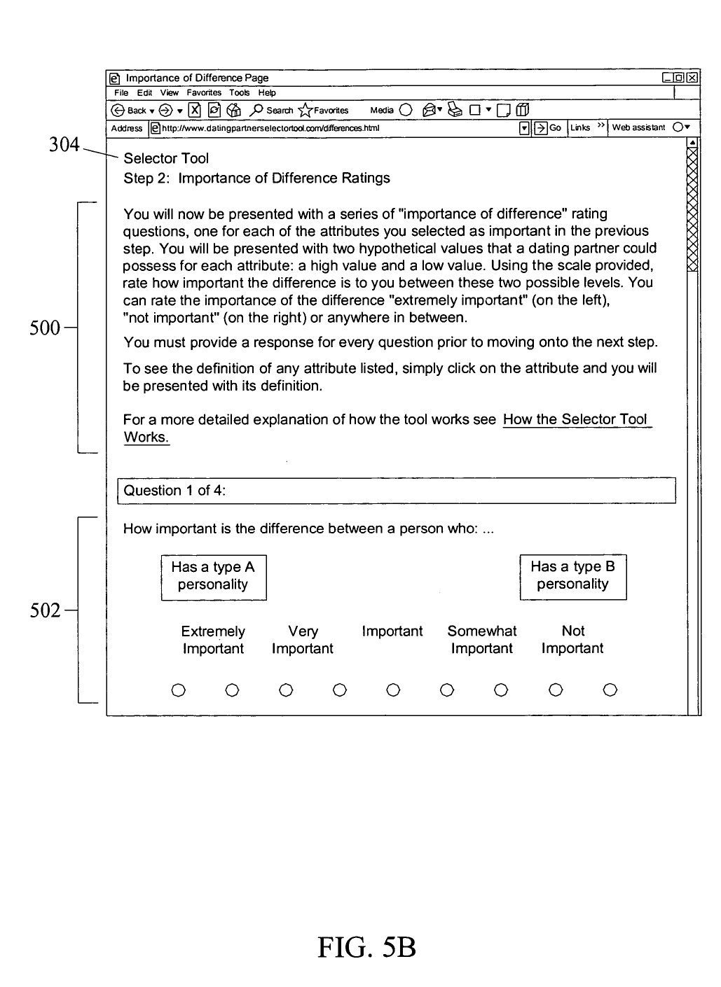

Referring back to FIG. 3, once the user has selected attributes that are of importance to the user, the user is presented with importance page 304, which allows the user to rate the importance of each attribute. FIG. 5A is a block diagram illustrating an exemplary embodiment of importance page 304. In FIG. 5A, importance page 304 includes an instructions portion 500 that explains to the user the mechanics of using importance page 304. Importance page 304 also includes an importance of difference portion 502 that presents the user with two hypothetical values that an automobile could possess for each attribute: a high value and a low value. A scale is provided that requires the user to rate how important the difference is to the user between the two possible alternatives. In the illustrated example, the attribute being evaluated is the price of an automobile. The user is asked to rate the importance of the difference between an automobile with a price of $20,000 and an automobile with a price of $50,000. A scale is provided below the choice that allows the user to rate the degree of importance between the two settings for each variable selected: a best setting and a worst setting.

FIG. 5B is a block diagram illustrating an exemplary importance of difference page 304 where the attribute being compared is personality type of a potential dating partner. The personality types of potential dating partners that are presented to the user may be selected based on results of a personality test presented to the user.

Although in FIGS. 4A, 4B, 5A, and 5B illustrate separate steps for selecting and rating attributes, the subject matter described herein is not limited to performing these steps separately. In an alternate implementation, the selecting and rating of attributes can be performed in a single step. For example, a user may select price as one important attribute in buying a house, rate the relative importance of price, and select a range of acceptable values in a single step. Combining the attribute selection and rating steps can reduce the amount of time for the user to complete the conjoint analysis.

The user is preferably presented with a series of preference pages 304 that require the user to rate the relative user's preference between best and worst settings of variables relating to an attribute. Once the user has completed the importance of difference rating step, referring back to FIG. 3, the user is presented with a series of paired trade-off pages 306. Each paired trade-off page 306 requires the user to rate paired sets of attributes. In particular, the user is presented with the best setting of one attribute and the worst setting of another attribute versus the worst setting of the first attribute and the best setting of the second attribute and the user is asked to rate the relative degree of importance of the best and worst settings of the different attributes.

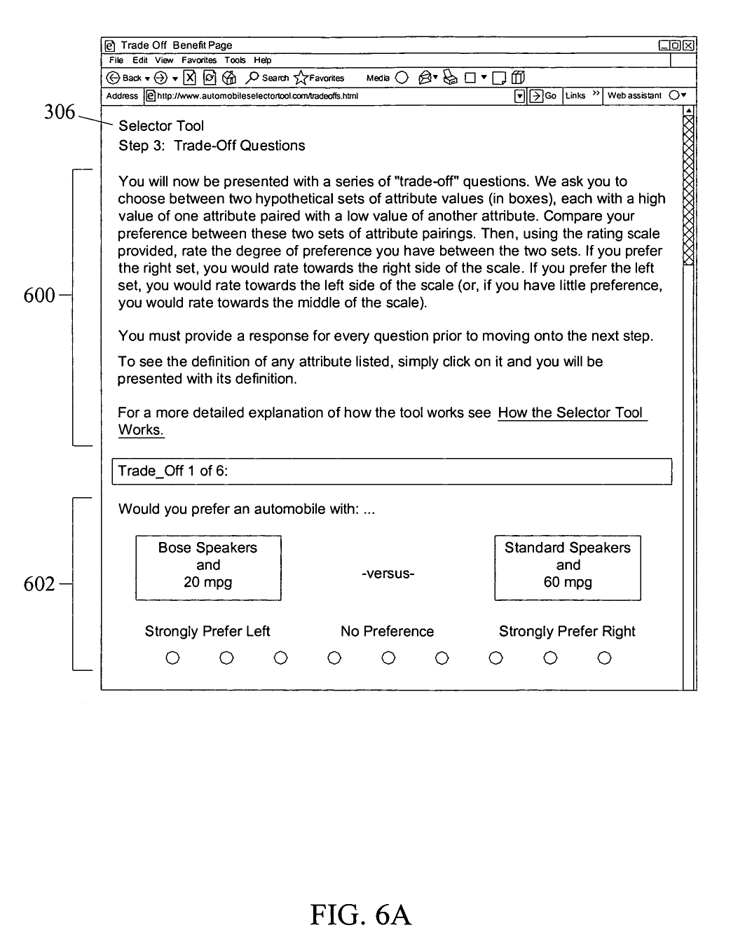

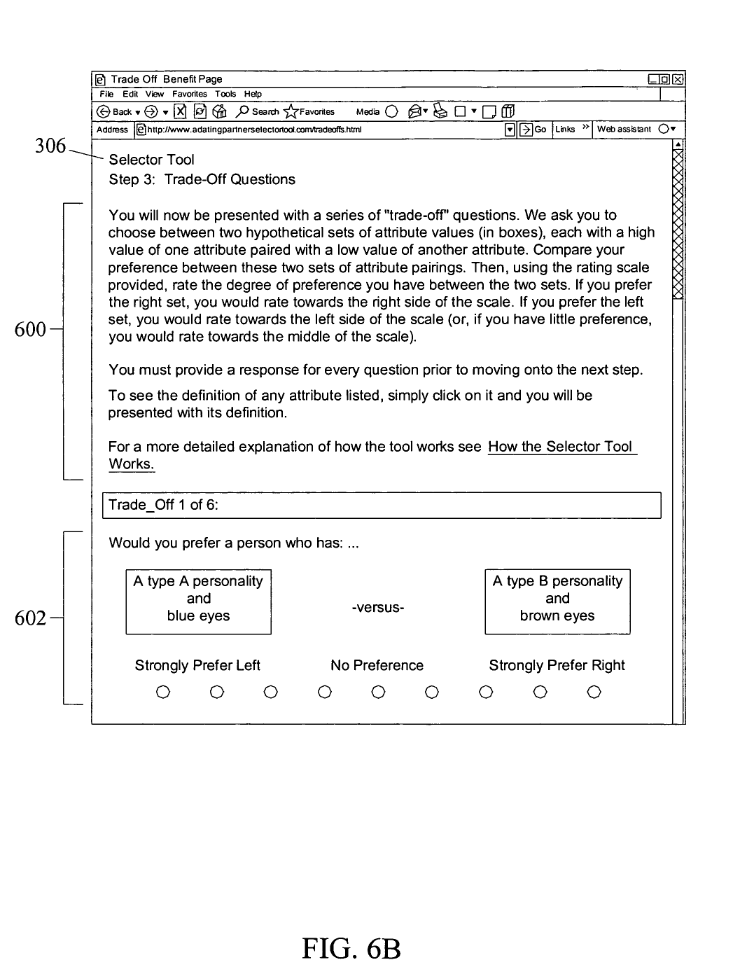

FIG. 6A illustrates an exemplary paired trade-off page 306 used to present tradeoffs between product attributes, where the attributes may be selected based on configuration software output. In FIG. 6A, paired trade-off page 306 includes instructions portion 600 that instructs the user on how to select between the alternatives presented on page 306. Paired trade-off page 306 also includes a trade-off selection portion 602, which presents the user with two pairings of two different attributes. In a preferred embodiment, the user is presented with a first pairing that includes a highest setting of one attribute and a lowest setting of another attribute and a second pairing that contains the highest setting of one attribute and the lowest setting of another attribute. For example, if the attributes are A1 and A2, the first pairing would be high(A1) AND low(A2), and the second pairing would be low(A1) AND high(A2). In the example illustrated in FIG. 6A, the pairings of attributes are as follows: an automobile with Bose speakers and a 20 MPG rating versus an automobile with standard speakers and a 60 MPG rating. The pairings represent combinations of high and low settings of the illustrated attributes—monthly contribution and annual deductible. The user is required to rate the user's preference between the pairings using discreet values on the scale provided below the pairings. For example, if the user strongly prefers an automobile with Bose speakers and a 20 MPG rating over an automobile with standard speakers and a 60 MPG rating, the user may select one of the circles on the left side of pair trade-off page 306.

FIG. 6B illustrates an example of paired tradeoff screen 306 in which conjoint analysis is combined with personality tests for an online dating service. In FIG. 6B, the user is asked to rate the user's preference between a person who has a type A personality and blue eyes and type B personality and brown eyes.

The user is presented with a series of paired trade-off screens 306 and is required to rate the user's preference for each of the pairings. Values indicative of each of the user-selected ratings are provided to utilities calculation engine 202 illustrated in FIG. 2.

Once the user has completed all of the importance pages 304 and paired trade-off pages 306, the selector tool performs the following steps:
1. Using utilities calculation engine 202, a “final computed importance” is calculated for each “attribute” used in the exercise. This is a measure of the relative importance of the “attribute” with respect to the “settings” of that “attribute” presented as well as to the relative importance of all the other “attributes.” For example, in the automobile configuration example presented above, each of the attributes of automobiles may be rated on a scale of 1-9 based on the user's answers to the user's questions. A similar rating may be performed for the personality test example.
2. Utilities calculation engine 202 gathers the performance levels (actual “settings”) for each “alternative” available to the “user,” for each “attribute.”
3. For each “alternative” and “attribute” utilities calculation engine 202 creates a “setting utility” score for each “alternative” available to the “user.” Details of this calculation are described below. The sum of the “setting utility” scores for all the “attributes” for an “alternative” become the “alternative's” “total utility” score. This value is unique to each “alternative”/“user” combination.
4. The “user” is then presented with a list of all the “alternatives” available to them with a graphical representation of the relative “total utility” scores of the “alternatives.” With this information, the user can ascertain how well each “alternative” matches their stated importance.

Referring back to FIG. 2, results page 308 presents the results from the utilities calculation to the user. The utilities are measured in terms of a preference value that indicates the relative utility of each choice to that particular user. Alternative choices may be sorted in any order, such as descending order.

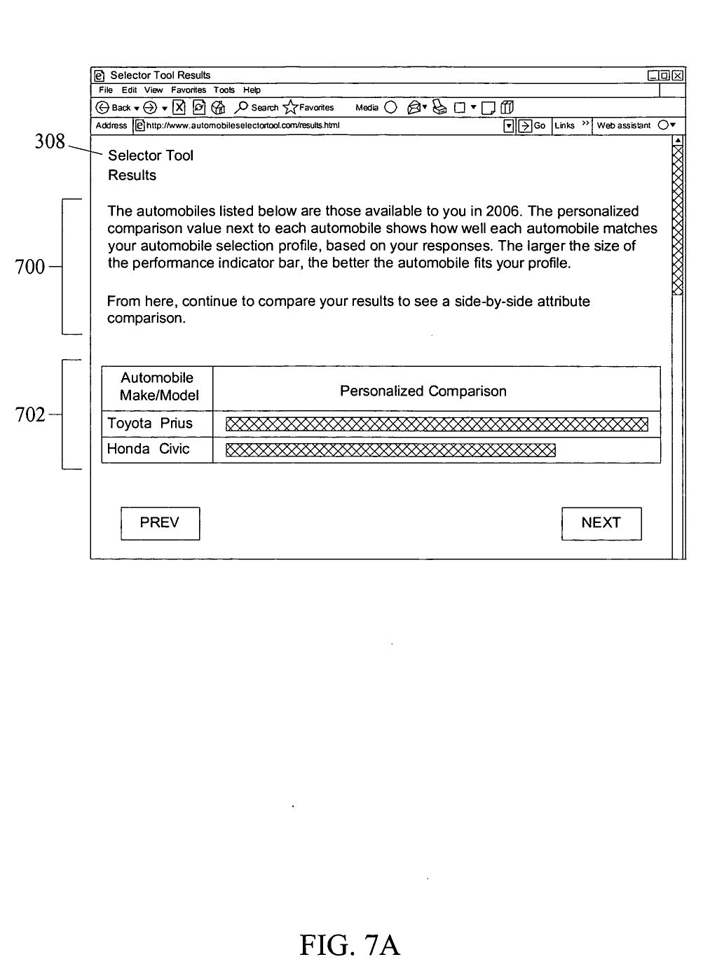

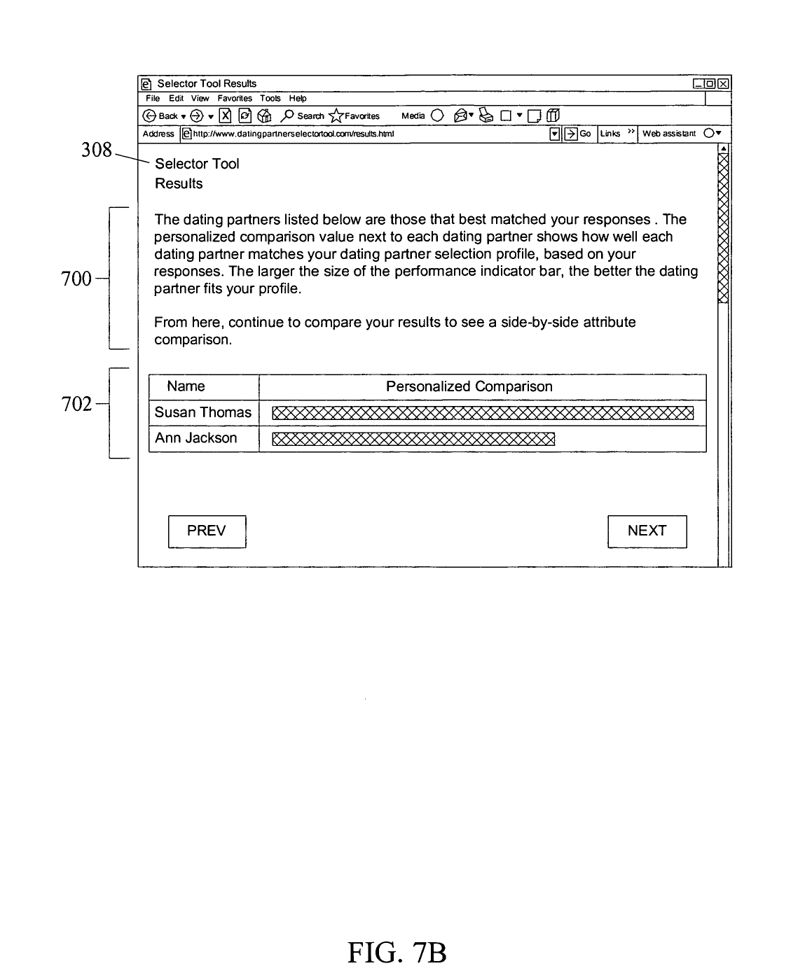

FIG. 7A illustrates an example of results page 308 for combining conjoint analysis with configuration software. In the illustrated example, results page 308 gives a relative importance of one automobile make and model with respect to another automobile make and model based on the responses provided by the user. From this comparison, the user can see that the first automobile make and model has a higher relative utility to the user than the second automobile make and model.

FIG. 7B illustrates an example of results page 308 for an embodiment of the subject matter described herein that combines conjoint analysis with personality tests. In FIG. 7B, results page 308 rates the relative desirability of two individuals in an online dating service where the two individuals are selected based on the user's answers to the questions described above.

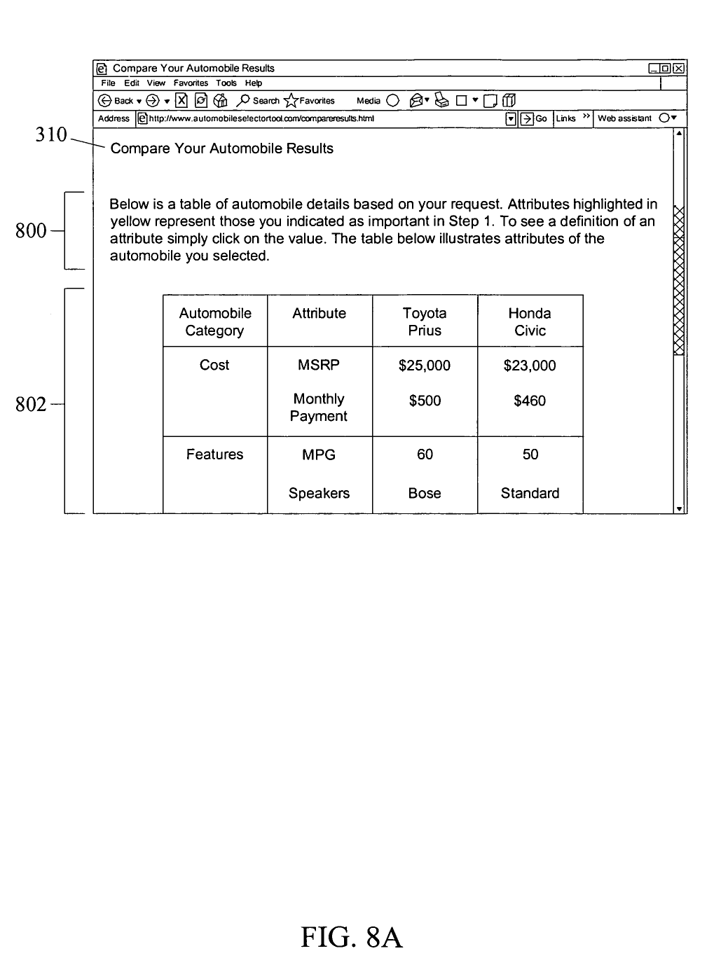

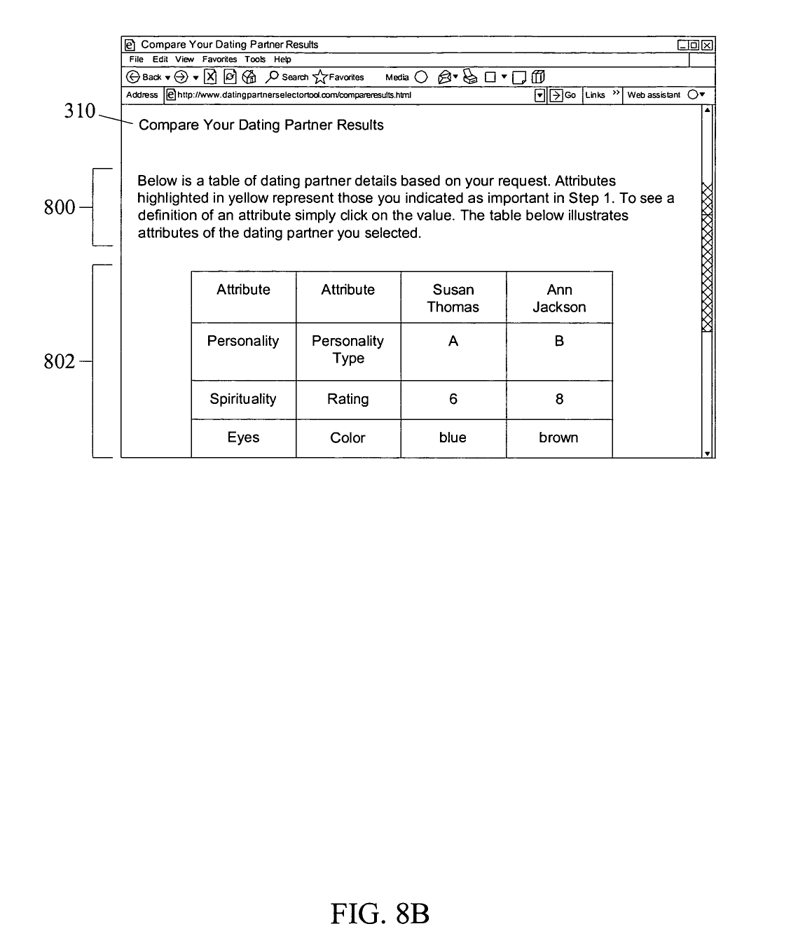

Referring back to FIG. 3, a details page 310 can be accessed from any of the other pages 300, 302, 304, 306, and 308. Details page 310 explains the feature of the page from which details page 310 was accessed. For example, if details page 310 is accessed from results page 308, a more comprehensive explanation of the results will be presented. FIG. 8A illustrates an example of details page 310 accessed from results page 308. Referring to FIG. 8A, details page 310 includes an explanation portion 800 that explains the content of details page 310. Details page 310 includes a content table 802 that compares the attributes of two choices presented to the user. In the illustrated example, the choices are attributes of automobiles.

FIG. 8B illustrates an example of details page 310 where the attributes being presented to the user are attributes of potential dating partners. By presenting the attributes in a table format, the user can compare potential dating partners on an attribute by attribute basis.

Thus, as illustrated above, the subject matter described herein provides a user-friendly graphical user interface that simplifies complex choices for users. The users are presented with two series of simple choices. Based on the user's responses to the simple choices, the utilities calculation engine of the subject matter described herein calculates the relative utility of complex choices for the user. By breaking the complex choices into series of simple choices, the subject matter described herein greatly facilitates user selection among complex choices.

### Detailed Description of Calculations Performed by Utilities Calculation Engine

The statistical algorithm implemented by utilities calculation engine 202 involves the calculation of “regression” coefficients (uₖ) for the equation:
yᵢ=aᵢ+u₁*a₁ᵢ+u₂*a₂ᵢ+ . . . +uₖ*aₖᵢ+eᵢ
where yᵢ is a variable with i possible observations per tool user, representing the quantitative values chosen by a individual to measure his or her judgment of the importance of the difference between some best value of each important “attribute” and some worst value of the “attribute”, as well as values input by that individual to measure his degree of attraction to either of two two-“attribute” alternatives (or choices) (in which the key characteristic of those two-“attribute” alternatives is that the first “attribute” has its best possible value while the second has its worst possible value, and the other alternative's two “attributes” have the characteristic that the first “attribute” has its worst possible value while the second “attribute” has its best possible value). It is important to note that while the “user” provides the relative degree to which he/she prefers one “best/worst” “alternative” (i.e. product) to the other, the algorithm for deriving “final estimated importances” (i.e. the regression analysis) interprets these responses as the mathematical difference in the “importances” of the two “attributes.” This property of the algorithm is so important that the following example is warranted to clearly illustrate the mechanics.

Assume the two “attributes” of a trade-off screen 306 are price and quality and assume the “alternatives” are bicycles. Thus, the trade-off screen might look like the following:

| | | |
|---|---|---|
| $500 | | $100 |
| High Quality | vs. | Low Quality |

| | | | | | | | | |
|---|---|---|---|---|---|---|---|---|
| −4 | −3 | −2 | −1 | 0 | +1 | +2 | +3 | +4 |

The user is asked to respond with a number between −4 and +4, with a −4 meaning he/she strongly prefers the High Quality, $500 bicycle and a +4 meaning he/she strongly prefers the Low Quality, $100 bicycle. Values between +4 and −4 indicate less strong preferences, with 0 (zero) indicating the user prefers the two bikes equally. Because all “attributes” are studied in the trade-off screens only in terms of their best and worst “settings” and also because exactly two “attributes” are studied in each trade-off screen 306, any value on the +4 to X continuum has a second interpretation, besides the relative preference of one “alternative” vs. the other, which is the mathematical difference in the “importance” of the two “attributes” being studied (where the “importance” values are on a +1 to +5 scale). Thus, if a user states a “+3” in the above trade-off, that can be interpreted to mean that price is more “important” than quality and precisely that the “importance” of price is 3 more “importance” points than the “importance” of quality. In other words, the user may have “importance” values for price and quality of +4 and +1 respectively, or +5 and +2 or +4.5 and +1.5 (the actual importance magnitudes are gauged elsewhere (not in the trade-off screens), in the “importance” (i.e. importance of difference) screens). Other trade-off values have similar interpretations (e.g. a “0” is interpreted as the “importance” of price and quality being equal; a “−4” is interpreted as the “importance” of price being 4 “importance” points less than the “importance” of quality (e.g. price “importance”=1 and quality “importance”=5). Another way to view this is that while the user is responding (with respect to moving from −4 to +4) in terms of left-of-screen “alternative” vs. right-of-screen “alternative,” the software algorithm interpretation is bottom-of-screen “attribute” vs. top-of-screen “attribute”.” This property (interpretation) of the algorithm may indeed be the single most unique aspect of utilities calculation engine 202.

The subject matter described herein is not limited to using any particular scale for rating user preferences with regard to difference in importance or trade-offs. The size and increments in the scale depend on the desired granularity and the algorithm used to generate the total utility value.

As described above, two types of data are gathered from users:
1. The importance of a single “attribute” (defined as the importance of the difference between the best and worst “settings” of that “attribute”), measured on a 1-to-5 scale (using importance pages 304).
2. The difference in the importance of two “attributes. Since the “importance” of each “attribute” is measured on a 1-to-5 scale (see 1 above), the “difference in importance” is measured on a −4-to-4 scale (since the minimum value is a 1 minus a 5 which equals 4 and the maximum value is a 5 minus a 1 which equals 4) (using paired trade-off pages 308).

Via regression analysis, both types of data are analyzed together as a single set of information. The result of this regression analysis is a single number for each “attribute” indicating the final estimate of how important the user feels the “attribute” is (on the original “importance” scale).

The way the data is coded is as follows:

### Dependent Variable Vector Y

Type 1 “importance” data is simply bottom-augmented with the type 2 “difference in importance” data. Thus, if a user had been asked about 5 “attributes” and had given “importance” scores of 5, 4, 3, 2, and 1, the Y “importance” data would equal:

$$\begin{matrix}5 \\ 4 \\ 3 \\ 2 \\ 1\end{matrix}$$

Similarly, if the user had seen 6 pairs of “attributes” and had given “difference in importance” ratings of −4, 3, 0, 1, 0, and −2, the Y “difference in importance” data would equal:

$$\begin{matrix}- 4 \\ 3 \\ 0 \\ 1 \\ 0 \\ - 2\end{matrix}$$

Thus, the final Y vector would equal:

$$\begin{matrix}1 & 0 & 0 & 0 & 0 \\ 0 & 1 & 0 & 0 & 0 \\ 0 & 0 & 1 & 0 & 0 \\ 0 & 0 & 0 & 1 & 0 \\ 0 & 0 & 0 & 0 & 1\end{matrix}$$

The number of rows equals the number of observations of data used in the regression analysis and is equal to the number of separate data values supplied by the user for “importance” and for “difference in importance” questions.

### Independent Variable Matrix X

The X matrix associated with Type 1 “importance” data is made of rows that are “dummy” coded with a “1” indicating the “attribute” the user is referring to and 0's otherwise. Thus, assuming the “importance” scores of 5, 4, 3, 2, and 1 given above were in the order of first, second, third, fourth, and fifth “attributes, the X “importance” data would equal:

$$\begin{matrix}5 \\ 4 \\ 3 \\ 2 \\ 1 \\ - 4 \\ 3 \\ 0 \\ 1 \\ 0 \\ 2\end{matrix}$$

Note that it is not necessary that the order is first, second, third, fourth, and fifth, however. If the data had been in, say, order of second, first, third, fourth, and fifth attributes, then the X matrix would have looked like:

$$\begin{matrix}0 & 1 & 0 & 0 & 0 \\ 1 & 0 & 0 & 0 & 0 \\ 0 & 0 & 1 & 0 & 0 \\ 0 & 0 & 0 & 1 & 0 \\ 0 & 0 & 0 & 0 & 1\end{matrix}$$

For this example, the former order is assumed.

In addition to determining an X-matrix for the importance data entered through importance pages 304, utilities calculation preferably also determines an X-matrix for difference of importance data collected through paired trade-off screens 306.

The X matrix associated with the “difference of importance” responses is made of rows that are coded as “1” if the “attribute” is one of the pair being traded off and is the “attribute” shown either at the top or the bottom of the screen, “−1” if the “attribute” is one of the pair being traded off and is the “attribute” shown opposite the other “attribute” (at bottom if former is at top of screen and vice versa), and “0” if the “attribute” is not one of the pair being traded off. For example, assuming that the “top-bottom” pairs of “attributes” are first-second, second-third, third-fourth, fourth-fifth, fifth-first, and fourth-second, and the top “attribute” has its best “setting” on the right side of the screen and bottom “attribute” has its best “setting” on the left side of the screen (though this may be interchanged), the X matrix associated with the “difference of importance” data equals

$$\begin{matrix}1 & - 1 & 0 & 0 & 0 \\ 0 & 1 & - 1 & 0 & 0 \\ 0 & 0 & 1 & - 1 & 0 \\ 0 & 0 & 0 & 1 & - 1 \\ - 1 & 0 & 0 & 0 & 1 \\ 0 & - 1 & 0 & 1 & 0\end{matrix}$$

The above X matrix is given only as an example. Pairings of “attributes” may be random or a systematic approach may be used to pair the attributes, as in an orthogonal or near-orthogonal design.

As before with the Y vector, the final X matrix is created by bottom-augmenting the “importance” data with the “difference in importance” data. Thus the final X matrix equals

$$\begin{matrix}1 & 0 & 0 & 0 & 0 \\ 0 & 0 & 0 & 0 & 0 \\ 0 & 1 & 0 & 0 & 0 \\ 0 & 0 & 1 & 0 & 0 \\ 0 & 0 & 0 & 1 & 0 \\ 1 & - 1 & 0 & 0 & 0 \\ 0 & 1 & - 1 & 0 & 0 \\ 0 & 0 & 1 & - 1 & 0 \\ 0 & 0 & 0 & 1 & - 1 \\ - 1 & 0 & 0 & 0 & 1 \\ 0 & - 1 & 0 & 1 & 0\end{matrix}$$

Thus, the final set of data to be analyzed is as follows:

| Y vector | X matrix |
|---|---|
| $\begin{matrix}5 \\ 4 \\ 3 \\ 2 \\ 1 \\ - 4 \\ 3 \\ 0 \\ 1 \\ 0 \\ - 2\end{matrix}$ | $\begin{matrix}1 & 0 & 0 & 0 & 0 \\ 0 & 1 & 0 & 0 & 0 \\ 0 & 0 & 1 & 0 & 0 \\ 0 & 0 & 0 & 1 & 0 \\ 0 & 0 & 0 & 0 & 1 \\ 1 & - 1 & 0 & 0 & 0 \\ 0 & 1 & - 1 & 0 & 0 \\ 0 & 0 & 1 & - 1 & 0 \\ 0 & 0 & 0 & 1 & - 1 \\ 0 & - 1 & 0 & 1 & 0\end{matrix}$ |

In summary, each row (of both the Y vector and the X matrix) represents a single response the “user” has given, the actual response being recorded in the Y vector. Each column of the X matrix represents an “attribute” the “user” has chosen as important (where rows with only 1's and 0's have a 1 in the column of the “attribute” that is the subject of the “importance”-of-difference screen and rows with 1's, 1's, and −1's have a 1 or −1 in a column to identify which attribute was at the top of and which attribute was at the bottom of the trade-off screen.

From this type data set, the B regression coefficients are calculated via
B=(X′X)⁻¹X′Y,
where ⁻¹ indicates the matrix inversion transformation and the single quote (′) indicates the matrix transpose transformation, are directly interpretable as importance (on the 1-to-5 “importance” scale) scores for the “attributes” they modify. Each B coefficient is paired with and thus modifies one “attribute.” A slight variation of this form is to include an additional column of ones (“1”s) in the leftmost position of the X matrix. The extra B coefficient in that instance is not associated with an “attribute” but is a measure of the intercept of the regression model, which theoretically equals zero. That is, in the absence of predicting anything about importance (e.g. an “importance” by plugging in a “1” or a “difference in importance” by plugging in a “1” and a “−1“), that is, only a series of zeros are plugged in, the model predicts zero. That is to say that the null condition of using the model to do nothing “predicts” a “0” (zero) “importance.”

Each user chooses which m or more “attributes” he/she actually uses in making a selection, where m is a variable threshold and is set in advance. If this number exceeds n then the top n (based on the user's “importance” scores (and predetermined expert judgments of the importance of “attributes” if a tie-breaker is needed)) are used and it is only these that have “final computed importances” calculated via the above formula. Again, n is a variable threshold that is set in advance. For excluded “attributes”, the “final computed importance” is set to zero. Thus, the number of “attributes” for which “final computed importances” are calculated varies from user to user. Currently, the software is written to allow for “importance” scores to be calculated for anywhere from four to fifteen “attributes” (that is, m=4 and n=15).

While it would be sufficient to simply use the (direct) “importance” scores for each “attribute” to help users select products/services, it is believed that the augmented data, the “difference in importance” data, greatly improves “final computed importances” and thus recommendation results. This is so because users are not actually told they are providing “difference in importance or trade-off” scores, but rather are told to gauge their preference for the best “setting” of one “attribute” paired with the worst of the other versus the worst “setting” of the one “attribute” paired with the best of the other. In this way, the user is actually comparing two products or services. Because only the best and worst “settings” are ever shown and because only two “attributes” are shown at a time, the interpretation of the responses is precisely “the mathematical difference in the importance of the two ‘attributes’ (each on a 1-to-5 scale).” This indirect way of obtaining information on the relative impact importance of “attributes” by comparing a series of hypothetical “alternatives” is a more realistic task for the “user” and is believed to enhance relative importance measurement.

With “final computed importances” estimated/calculated, the algorithm moves to using that data to calculate “total utility” scores for each product or service the user is in the market to buy and is eligible to buy. For each “attribute”, the “final computed importance” (i.e. the B coefficient from the “attribute”) is taken as the value of the worst “setting” of the “attribute” and five times the “final computed importance” is taken to be the value of the best “setting” of the “attribute”. Then, using linear interpolation, the “setting” or specification of each product or service is transformed to a value to be presented to the user. For example, if the “final computed importance” of price is 3.2 and the worst price “setting” is $50, and the best price “setting” is $10, then a product with a price of $23.33 would have a “setting utility” for price of
3.2+(5*3.2−3.2)*((23.33−50)/(10−50))=11.7344.

The utility numbers are “unitless.” That is; 10.6656 is not 10.6656 dollars or anything else. They are relative numbers that allow for comparing specifications on different “attributes” for a given user. A “setting” on an “attribute” that has a “10” value for user is worth more than a “setting” on the same or another “attribute” that has a value of, say, “7.” Individual “attribute” values are summed across the “attributes” making up the products or services, yielding a “total utility” score for each product or service for each user.

Utilities calculation engine 202 then rank orders the products or services for the user, in descending order of “total utility.” The top product or service in this list is the best recommendation for the product or service the user should choose, given the relative importance the user places on the various “attributes” that make up the products or services and the actual specifications of the products or services.

Although the subject matter described herein can be used to calculate relative total utilities of complex alternatives based on any number of attributes and attribute pairings, the following examples illustrate exemplary numbers of attributes and corresponding attribute pairings suitable for use with the subject matter described herein.

(1) 4 “attribute” engine

| Pairs | Interpretation |
|---|---|
| 1, 4 | This array of paired integers describes the comparisons |
| 2, 3 | of combinations of “attributes” made by utilities |
| 3, 4 | calculation engine 202. The pairings listed here are for 4 |
| 4, 2 | attributes and are believed to be unique. The remaining |
| 3, 1 | pairings listed herein are for 5 to 15 attributes and are |
| 1, 2 | also believed to be unique. |

```
(2) 5 “attribute” engine
1, 2
2, 4
5, 3
3, 1
1, 4
3, 4
1, 5
5, 2
(3) 6 “attribute” engine
1, 2
2, 4
5, 3
3, 1
6, 4
1, 6
3, 4
2, 5
(4) 7 “attribute” engine
1, 2
2, 4
5, 2
6, 7
3, 1
7, 3
1, 6
3, 4
4, 5
(5) 8 “attribute” engine
1, 2
5, 8
2, 4
5, 2
6, 7
3, 1
7, 3
1, 6
3, 4
8, 6
4, 5
(6) 9 “attribute” engine
1, 2
9, 7
2, 4
7, 3
4, 5
6, 1
5, 2
8, 6
3, 1
8, 9
4, 3
(7) 10 “attribute” engine
1, 2
9, 7
2, 4
7, 3
4, 5
10, 9
6, 1
5, 2
4, 3
8, 6
3, 1
  8, 10
(8) 11 “attribute” engine
1, 2
9, 7
2, 4
7, 3
4, 5
10, 11
6, 1
5, 2
4, 3
11, 9
8, 6
3, 1
  8, 10
(9) 12 “attribute” engine
1, 2
9, 7
2, 4
10, 12
7, 3
4, 5
12, 11
6, 1
5, 2
11, 9
4, 3
8, 6
3, 1
  8, 10
(10) 13 “attribute” engine
11, 13
1, 2,
9, 7
2, 4
10, 12
7, 3
4, 5
12, 11
6, 1
5, 2
11, 9
4, 3
8, 6
3, 1
  8, 10
13, 9
(11) 14 “attribute” engine
11, 13
1, 2
9, 7
2, 4
10, 12
7, 3
4, 5
12, 11
6, 1
5, 2
14, 12
11, 9
4, 3
10, 14
8, 6
3, 1
  8, 10
13, 9
(11) 15 “attribute” engine
11, 13
1, 2
  8, 15
9, 7
2, 3
10, 12
7, 3
4, 5
12, 11
6, 1
5, 2
14, 12
11, 10
4, 3
10, 14
8, 6
15, 14
3, 1
  8, 10
13, 9
```

In all the above, the numbers in the pairs (e.g. “13,9“) signify the two attributes in terms of the rank order of their “importance” ratings by the user. For instance, “13,9” signifies the 13^{th} most important attribute and the 9^{th} most important attribute.

### Summary

To summarize exemplary selector tool operation, the operation may include the following steps:
1. Create a list of product or service attributes, which can be objectively collected for all products or services offered. Create levels for these attributes so their values can be compared.
2. Allow users of the software to simply click on those attributes or features, which are important to them.
3. For each attribute selected, show the high and low levels for each, and ask the user to determine how important the difference between the extremes are in their selection process.
4. Using the algorithms discussed above, present the user with unique combinations (paired comparisons) of attributes which they have indicated as very important, and force them to make trade-off decisions between hypothetical plans/products which contain these features.
5. Present the results of their preference exercise by showing them all products available to them in priority order, based on how well each product fits the user's profile
6. Allow the user to access a “Compare” feature, which allows the user to compare any four plans or products; side-by-side, feature-by-feature
7. Allow the user to purchase or enroll in whatever they choose.
   When these steps are combined with configuration software, personality tests, or skills tests, the result is an efficient decision tool capable of aiding in selection of products, services, or other complex alternatives that takes into account both objective and subjective attributes.

### Scalability, Adaptability, and Efficiency

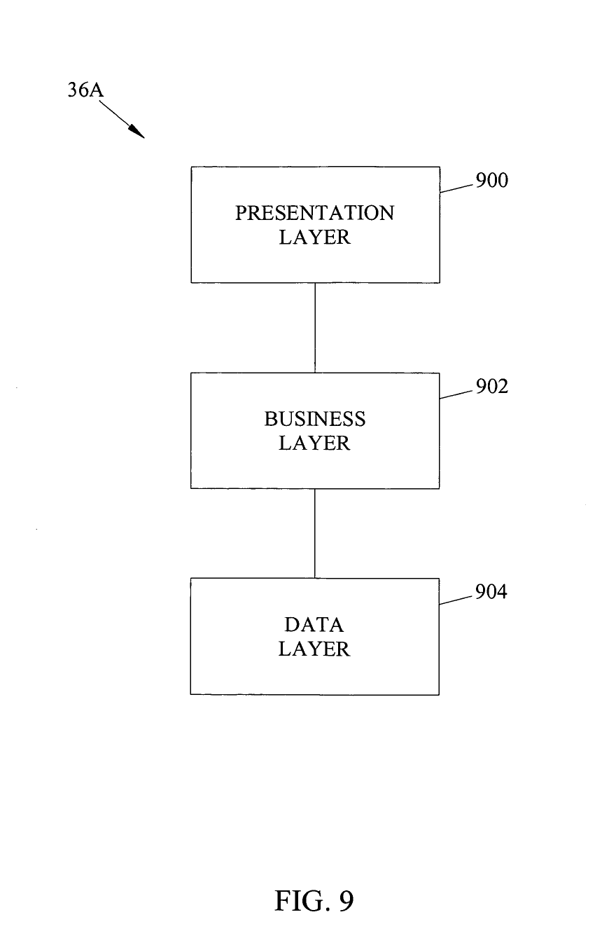

Another aspect of the subject matter described herein is its scalability and ability to adapt to different applications. FIG. 9 shown below is a block diagram of a preferred embodiment of a selector tool server according to an embodiment of the subject matter described herein. In FIG. 9, selector tool server 36A includes presentation layer 900, business layer 902, and data layer 904. Presentation layer 900 contains functions for presenting text and graphics to the user. Business layer 902 includes components, which are separately compiled from application layer code, and extract and store data in data layer 904. Data Layer 904 stores data, such as attributes and available products or services, for a given application.

Presentation layer 900 may be written in any suitable presentation layer language, such as Microsoft Active Server Pages (ASP). Microsoft ASP is a script-based language that uses HTML for presentation. The present subject matter is not limited to using Microsoft ASP. Other languages that could be used include JSP—a Java-based language, or Cold Fusion. Presentation layer 900 is written to handle any client and any complex decision. Components that change from one application to another are data driven. For example, in order to modify the selector tool for use with a new application, it is not necessary to modify the code that creates the various graphical user interfaces. It is only necessary to modify data that changes from one application to the next, which is stored in data layer 904. For example to change from product selector tool to a potential mate selector tool, it is only necessary to change the attributes and the available selections in data layer 904.

According to another aspect of the subject matter described herein, selector tool server 36A may run session-less. For example, when the user changes from one screen to the next, server identification of the user was previously accomplished using a session-level variable. Currently, a temporary cookie is created in the user's browser when a user first accesses the tool. The cookie holds a unique identifier to identify the user as the user changes from page to page.

According to yet another aspect of the subject matter described herein, no database calls done through presentation layer 900. All calls to the database are done via components, which are part of business layer 902. Using components to access data greatly reduces overhead. As discussed above, a component is a separately compiled piece of code with a dedicated function, such as “get product IDs available for this user.” These components are called by presentation layer 900 when the function is needed. For example, for the attribute selection page, an attribute selection component extracts the attributes that are available for a specific user. Another component present in business layer 902 is the conjoint analysis engine, which is described in detail above.

According to another aspect of the subject matter described herein, content, such as instructions for using the tool and other material displayable by the selector tool server, is preferably located in a content database in data layer 904. Storing the content in a content database allows content to be quickly altered and customized for new clients or changing client needs. Data layer 904 may be implemented using any suitable database language, such as Microsoft Structured Query Language (SQL) Server Version 7.0.

According to yet another aspect of the subject matter described herein, the underlying data schema has been created to be flexible and “generic.” As used herein, the phrase “data schema” refers to the data structures and databases in data layer 904 used to generate the attributes and questions presented to the user. Rather than product or company-specific data structures, data structures are now generic. For example, rather that having a data structure created around the specific functional needs and specificities of a single client/product (i.e., automobiles available to user A), a generic data schema has been developed that accommodates the data needs of the application regardless of the client and or product category. As a result providing generic data structures, the selector tool can be used for multiple clients and among multiple product categories, with little if any changes to the data schema.

According to another aspect of the subject matter described herein, all frequently used query objects are indexed. A query object is a field in a database in data layer 904 that the selector tool might access. Indexing allows faster access to frequently accessed data.

As a result of the features listed above and factors relating to efficient coding, the selector tool server is capable of meeting the needs of multiple clients simultaneously.

Combining Psychological and Skills Tests with Conjoint Analysis

As described above, the methods and systems described herein facilitate user choices among complex alternatives using conjoint analysis. In addition, the methods and systems described herein can be used in combination with psychological and/or skills tests to even further facilitate user choices among complex alternatives. Certain types of psychological tests may work well in combination with the conjoint software to help people make decisions that more closely match their preferences. Psychological tests falling into the following categories may work in combination with conjoint analysis include: 1) aptitude tests, 2) achievement tests, 3) intelligence tests, 4) skills tests, 5) compatibility tests, and 6) stress or anxiety tests.

Achievement and aptitude tests are most often used in educational or employment settings, and they attempt to measure either how much you know about a certain topic (i.e., your achieved knowledge), such as mathematics or spelling, or how much of a capacity you have (i.e., your aptitude) to master material in a particular area, such as mechanical relationships.

Intelligence tests attempt to measure your intelligence, or your basic ability to understand the world around you, assimilate its functioning, and apply this knowledge to enhance the quality of your life. These tests attempt to measure a potential, not a measure of what you've learned (as in an achievement test), and so it is supposed to be independent of culture.

Skills tests attempt to measure your abilities, both learned and natural. Skills tests may measure perceived abilities in performing tasks, such as solving puzzles or problems, fixing things, designing things, and the ability to perform a wide variety of functions, from driving a car to using a computer program, to using a variety of tools or equipment. Skills tests may also be used to evaluate physical abilities, such as running, shooting a basketball, hitting a baseball or performing gymnastic exercises. The results of skills tests may be used in combination with conjoint analysis to help an individual—or a company—determine the level of appropriate fit for an individual in job hunting, ability to use a piece of equipment effectively, or the fit for that individual across a wide range of choices in products, services or employment. The results of such tests may also be used as a filter for conjoint analysis attributes or result in the same manner described above for psychological tests.

Compatibility tests are commonly used by psychologists, employers, online dating services and marriage counseling to determine if two individuals are compatible for dating, companionship, or even marriage. Compatibility tests are also used by employers to determine if an applicant is suitable for a given employment position, including attributes related to how the person deals with stress, how extraverted or introverted the person might be, how creative the person is, how he or she manages time and how they interact with others; just to name a few areas of use for compatibility tests.

Personality tests which relate to dealing with stress and anxiety come in two forms: 1) tests which determine the range of tolerance a person has making decisions in a variety of situations, and 2) tests which segment areas where a person is more or less willing to make decisions. Any one or more of these tests may be used with conjoint analysis to facilitate user selection among complex alternatives.

For example, conjoint analysis may be used in combination with personality tests for matching buyers and sellers of any product or service and individuals or groups attempting to determine optimum compatibility for meeting, hiring, partnering, merging, dating or marrying.

Decision theory understands that all people are often attempting to find the best match between alternative options. Whether attempting to purchase an automobile, a house, a computer, a business or to identify highly compatible individuals for dating and marrying; these decisions are complex and difficult. Using preference profiling as described above, individuals can identify attributes of a given product, person or service, rate those attributes and then make tradeoff decisions between pairs of those attributes. The profile, mapped against a database of products, people or services, can help consumers identify products or services, which best match their profile. It is intuitive, relatively easy to perform the tasks, and the results can make consumers more comfortable with their decisions.

In an extension to this technique, preference profiling can be improved by combining the technique with personality tests. While the preference profiling allows an individual to list attributes and make trade-offs, it is largely an intellectual, thinking (usually associated left brain) process. This process can be significantly enhanced by combining the results of psychology-based personality tests (associated with right brain activity) with the conjoint decision process so that a combination of personality characteristics and personal preferences adds considerable precision to the results.

It is believed that combining these processes will significantly improve the chances that the choices, selections and matches which result from this exercise will be more satisfying, mutually beneficial and longer-lasting.

Any suitable psychological test may be used in combination with conjoint analysis to facilitate user choices among complex alternatives. For example, there are a wide array of personality tests used by psychologists, teachers, counselors and tests available directly to consumers through books, magazines and The Internet. Online dating services, such as Match.com, eHarmony and others, have developed their own personality tests, the results of which are used to help match compatible individuals. In business, personality tests are used to determine if employees are good matches for a position and for the company. Personality tests are used to help families, management teams, athletic teams and other groups work more effectively together. Currently, none of these tests have been combined with conjoint analysis to aid in decision-making.

According to one embodiment of the subject matter described herein, an individual, a couple, or group of individuals may begin a decision or matching process by taking a psychological test or skills test determined to be appropriate for the given decision or matching arena. Any of the tests listed above may be used, depending on the specific decision being made (e.g. dating, recruiting, house purchase, car purchase, etc.).

After taking the psychological or skills test, the results may be mapped in at least two ways: 1) some or all of the results may be used to limit and select the array of attributes to be displayed at the beginning of the preference profiling module, which uses conjoint analysis; and 2) some or all of the psychological test results may be mapped to the database of products, services, companies or individuals which are included in the decision process and used to either select or de-select those items which will be considered in the search results.

The results of choices made using conjoint analysis and personality tests in combination may be better than the results of choices made without the benefit of either of these tools and better than the results of choices made using either of these tools individually. The combination of an intellectual, thinking process (attribute selection and tradeoff exercises) and a more emotional, “feeling” process derived through personality tests provides a much richer profiling result and selections and matches which are much more likely to be successful.

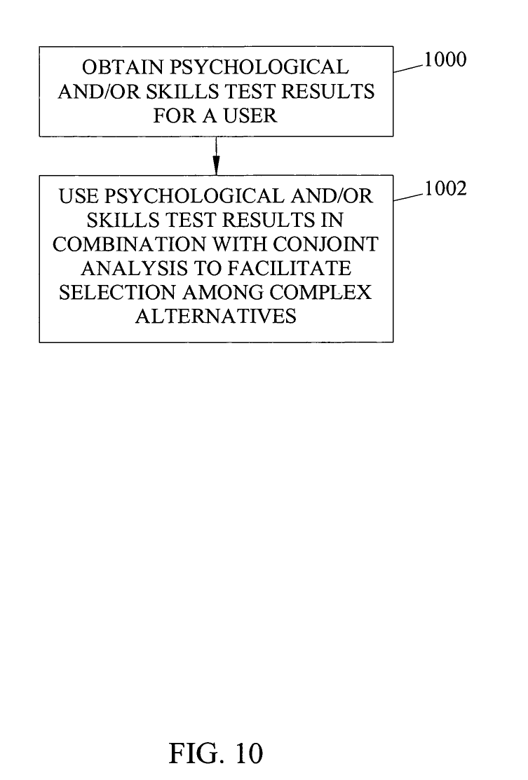

FIG. 10 is a flow chart illustrating exemplary steps for combining psychological and/or skills tests with conjoint analysis according to an embodiment of the subject matter described herein. Referring to FIG. 10, in step 1000, psychological and/or skills test results are obtained for an individual. The individual may be the person who is selecting among the complex alternatives using conjoint analysis or an individual being selected using the conjoint analysis. In step 1002, the psychological and/or skills test results are used in combination with the conjoint analysis to facilitate selection among complex alternatives. As stated above, in one exemplary implementation, psychological and/or skills test results may be used to limit or select the attributes presented to the user in performing conjoint analysis. In an alternate implementation, the psychological and/or skills test results may be used to limit or select the results presented to the user after the conjoint analysis.

### Psychological Test Example

An example of a psychological test which is used to determine compatability between two people is a test called InSync, developed by David Olsen, PhD., from The University of Minnesota, St. Paul and a company called Life Innovations, Inc.

### InSync Matching & Compatibility Systems

The InSync Matching System enables people to determine compatibility by taking a personality test that has scales on demographic and personality traits. The user answers a series of questions about themselves (demographics) and then a series of questions related to their attitudes toward themselves and potential dates. The result is a report that helps the user understand their desires for a date and, with many others taking this psychological compatibility test, allows the InSync System to present an in-depth profile of the user and attempt to match each individual user to others who have taken the test and who are determined to be compatible. Below is a sample of the InSync System categories and the potential number of answers (in parenthesis):

Background or Demographic Information:

| | |
|---|---|
| Age | (Select from a common list) |
| Education | (Select from a common list) |
| Ethnicity | (Select from a common list) |
| Religion | (Select from a common list) |
| Marital Status | (Select from a common list) |
| Hair Color | (Select from a category) |
| Eye Color | (Select from a category) |
| Children | (Want/Don't want, Have/#) |
| Smoker | (Smoker/Non-Smoker) |
| Income | (Select from a category) |

Personal Characteristics:

| | |
|---|---|
| Interests or Activities | (Select from a common list) (15 possible) |
| Personality | (Select from a common list) (16 possible) |
| Morning or Evening Person | (Select from a category) |
| Spender or Saver | (Select from a category) |
| Importance of Being on Time | (Select from a category) |
| Importance of Exercise | (Select from a category) |
| Body Type | (Select from a category) |
| Dating Expectations | (1-10 scale) |
| Comfort In Dating | (1-10 scale) |
| Togetherness | (1-10 scale) |
| Flexibility | (1-10 scale) |
| Gender roles | (1-10 scale) |
| Sexual Intimacy | (1-10 scale) |
| Spirituality | (1-10 scale) |
| Self Confidence | (1-10 scale) |
| Closeness in Family | (1-10 scale) |

Further explanation of some of the categories above:
Dating Expectations: Realistic expectations about dating.
Comfort in Dating: Enjoyment of dating process.
Communication: Expressing your thoughts & feelings.
Togetherness: Balancing time alone & with others.
Flexibility: Your organizational style.
Gender Roles: Your views on role sharing.
Sexual Intimacy: How you connect intimacy & sexuality.
Spirituality: Your spiritual beliefs & values.
Self Confidence: Your feelings about yourself.
Closeness in Family: Your feelings about your family of origin.

As an example of how the conjoint matching system is combined with a personality test, such the InSync System, the items above, both demographic/background questions and the results of the personality questions would become attributes in a conjoint exercise. Below is an example:

Instructions for the User:

Please click on all attributes below that you believe are important in identifying and selecting a person to date: For the purpose of this example, the user selects 8 attributes from above:
1. Age
2. Education
3. Religion
4. Interests & Activities
5. Spender/Saver
6. Spirituality
7. Income
8. Communications

It is expected that most users would select (click) on at least 10 attributes and, in our experience, most would select in the range of 15 attributes.

The selector tool may then ask the user to rate (on a 1-5 or 1-9 scale) how important each attribute is to them. Based upon which attributes they select and the importance rating for each attribute, the selector tool may set-up a paired-comparison trade-off exercise for each user. The pairs may be as follows:

If you had a choice of

| | | |
|---|---|---|
| A person 45 years old | | A person 55 years old |
| who is | vs | who is |
| A spender | | A saver |

Which would you choose?
1 2 3 4 5 6 7 8 9

If you had a choice of

| | | |
|---|---|---|
| A person who communicates easily | | A person who communicates |
| and is a spender | vs | poorly and is a saver |

Which would you choose?
1 2 3 4 5 6 7 8 9

If you had a choice of

| | | |
|---|---|---|
| A person with 16 years of education | | A person with 10 years of |
| With | vs | education |
| Income of $50,000 annually | | With |
| | | With income of $100,000 |
| | | annually |

Which would you choose?
1 2 3 4 5 6 7 8 9

If you had a choice of

| | | |
|---|---|---|
| A person who is a smoker | | A person who is a non-smoker |
| Who | vs | Who |
| Loves the outdoors | | Likes indoor activities |

Which would you choose?
1 2 3 4 5 6 7 8 9

These are examples of trade-off decisions the user would be required to make, which would allow the system to prioritize and order the importance of a range of personality and demographic attributes. With the ordering of attributes from this psychological test, the conjoint system would then be able to map each user's preference profile to a database of other people who have taken the psychological (InSync) test and match them according to common interests and preferences.

The above example illustrates how conjoint analysis can be used in an on-line or computer based dating system. Such a system can be used to match never married single people of all ages, divorced persons seeking dates, marriage and companionship and senior citizens for dating or simply companionship. This system may be operable to match people of all ages, genders, demographic backgrounds and personality make-ups.

### Combining Conjoint Analysis with Configuration Software

Configuration software applications have been developed over the last 20 years to assist product and service developers and the purchasers of products and services to “design” whole products from an array or assortment of product features. While adaptive conjoint determines the order of a persons preferences for features of products or services, configuration applications attempt to guide a user through the possible features of a product or service and demonstrate the limitations on what combinations of features are allowable, based upon engineering constraints or possibly optimized bundling of features for marketing purposes.

A simple example of configuration software might be a “build your own” software module on an automotive manufacturing website. The prospective purchaser is allowed to order an automobile by selecting such items as 1) engine size, 2) engine horsepower, 3) type of transmission (automatic, stick (3 speed, 4 speed, 5 speed) 4) body style, 5) locking system (manual or keyless), 6) colors, 7) trim, 8) interior materials, 9) sound system, 10) sun roof, moon roof or standard, etc., etc. The configuration software allows a user to select the features they desire for the bundled product or service, and is specifically designed to constrain the options in such a way that only compatible parts can be selected for the bundled product. As an example, configuration software would not allow a user to select an automobile transmission that would not function properly with a given engine. An additional, configuration software would not allow a user to select an operating system for a computer which required more random access memory than the user might choose.

This software currently exists and is offered by multiple software providers. A similar approach can be used for “building” computers, houses, motorcycles, boats, farm equipment, and even such things as health plans, financial plans and consulting services. The possibilities are very broad for use of this approach.

As described above, adaptive conjoint may be used across a similarly broad array of domains. However, it is believed that conjoint analysis has not been previously combined with configuration software to further enhance the decision making process.

Similar to the use of psychological test results in combination with the adaptive conjoint software described herein, configuration test results may be combined with conjoint analysis in a number of different ways. In one exemplary implementation, configuration software may be combined with conjoint analysis by using the configuration software to determine which attributes are presented for selection to a user at the beginning of the tradeoff exercise. In an alternate implementation, the adaptive conjoint exercise may be used to determine which limited number of attributes are to be included in the configuration process.

In the first example, for instance in “building” an automobile, the configuration software may determine that the user cannot have an eight cylinder engine with a five speed manual transmission, or that the user can't have a choice between Bose speakers with a cassette tape stereo. Similarly, if the conjoint exercise is conducted first, it might determine which features or attributes are displayed or allowed in the configuration exercise.

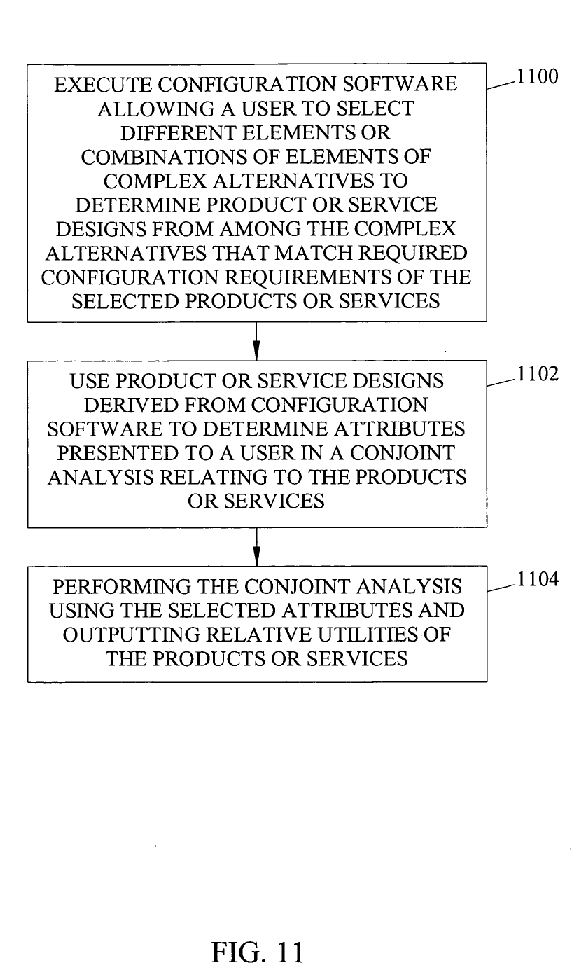

FIG. 11 is a flow chart illustrating exemplary steps for combining conjoint analysis and configuration software according to an embodiment of the subject matter described herein. Referring to FIG. 11, in step 1100, configuration software is executed. The configuration software allows a user to select different elements or combinations of elements of complex alternatives to determine product or service designs from among the complex alternatives that match the required configuration requirements of the selected products of services. In step 1102, the product or service designs derived from the configuration software are used to determine attributes to be presented to the user in a conjoint analysis relating to the products or services. In step 1104, conjoint analysis is performed using the selected attributes and relative utilities relating to the products or services are output. Thus, by using configuration software as a front end to conjoint analysis, the number of attributes is reduced and the likelihood that an operable product will be selected is increased.

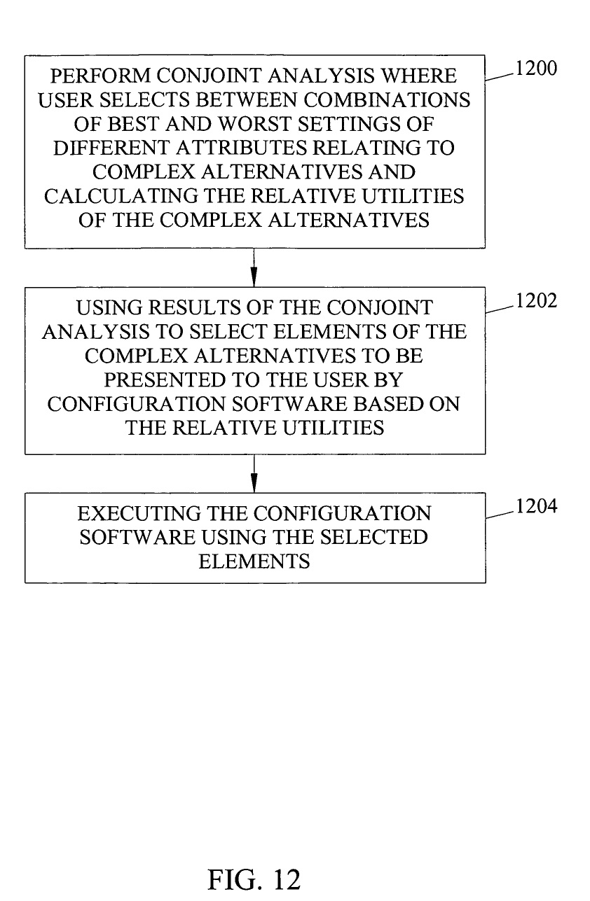

In an alternate implementation, conjoint analysis results may be used as input to product configuration software. FIG. 12 illustrates exemplary steps that may be performed in combining conjoint analysis and product configuration software where conjoint analysis results are used as input to the configuration software. Referring to FIG. 12, in step 1200, conjoint analysis where a user selects between combinations of best and worst settings of different attributes relating to complex alternatives is performed. The conjoint analysis calculates relative utilities of the complex alternatives. In step 1202, results of the conjoint analysis are used to select an element of the complex alternatives to be presented to the user by the configuration software based on the relative utilities. In step 1204, the configuration software is executed using the selected elements. Thus, by using conjoint analysis as a front end to configuration software, the number of elements that must be processed by the configuration software is reduced, and therefore the efficiency of the software is increased.

### Configuration Software Example

### EXAMPLE 1

### Automobiles or Trucks

Configuration software has been developed across a wide range of products and services. Companies like Dell Computer, Gateway and IBM offer software online which allows the user to design a computer that fits his or her needs. Most major truck manufacturers use software which allows the buyer to choose features of a truck that meet the needs and preferences of the buyer, while assuring that the combination of features are compatible. Many automobile manufacturers have software online which allows a buyer to design a car that meets their needs. There is a wide range of sophistication in configuration software available in the marketplace. In all cases, however, configuration software is designed so that the person using the software and making a selection will order merchandise or a service in which all of the components are compatible.

Without configuration software, it might be possible for a person to purchase a semi-tractor-trailer with an engine that would be too large for the transmission, or a truck with tires that would not hold-up under the road conditions where the truck would most often be used or to purchase a truck that cannot haul the load over a mountain-range because the combination of engine power, transmission and weight of the load are not compatible.

In the area of computers, without the ability of a user to configure the design of a computer he or she is purchasing, it would be very possible to purchase a system that will not handle the demands of the software because there is not enough random access memory or to purchase a computer that will not have the speed to manage thousands of simultaneous transactions. Each purchaser of a computer must be able to select a design that will meet the user's particular needs. Configuration software helps to assure the purchaser that they will purchase what they want, and more particularly, that all of the parts will work effectively together.

The combination of configuration software and conjoint analysis adds greater assurance to the purchaser that they are not only getting something that will meet their needs, and that they will be purchasing something that is optimized to their personal preferences. Below are some examples of how a system that combines conjoint analysis with configuration software may function:

For the purchaser of a automobile:

Background or Demographic Information:

| | |
|---|---|
| Price | (Select from a common list) |
| Financing | (Payment options and interest rates) |
| Speed | (0 to X miles per hour, in seconds) |
| Style | (Select from a common list) |
| Transmission | (Select from a common list) |
| Sound system | (Select from a common list) |
| GPS | (Select from a category) (Yes/No) |
| Horsepower | (Select from a category) |
| Color | ((Select from a category) |
| Warranty | (Length and cost of warranty) |
| Safety | (Select from a category) |
| Seating | (Number of seats) |
| Fuel Efficiency | (Select from a range) |

Configuration attributes become attributes in a conjoint exercise. Below is an example:
Instructions for the User:

Please click on all attributes below that you believe are important in identifying and selecting a person to date: For the purpose of this example, the user selects 6 attributes from above:
1. Price
2. Financing
3. GPS
4. Warranty
5. Fuel Efficiency
6. Speed

It is expected that most users would select (click) on at least 10 attributes and, in our experience, most would select in the range of 15 attributes.

The selector tool may then ask the user to rate (on a 1-5 or 1-9 scale) how important each attribute is to him or her. Based upon which attributes they select and the importance rating for each attribute, the selector tool may set-up a paired-comparison trade-off exercise for each user. The pairs may be as follows:

If you had a choice of a car that

| Goes 0 to 60 in 4.5 seconds | | Goes 0 to 60 in 7 seconds |
|---|---|---|
| That costs | vs | That costs |
| $30,000 | | $22,000 |

Which would you choose?
1 2 3 4 5 6 7 8 9

If you had a choice of a car

| | | |
|---|---|---|
| With a GPS system | | Without a GPS system |
| and that Seats | vs | and that seats |
| 7 passengers | | 2 passengers |

Which would you choose?
1 2 3 4 5 6 7 8 9

If you had a choice of a car with

| A 5 year warranty at no additional cost | | A 3 year warranty and $300 |
|---|---|---|
| and | vs | optional warranty |
| Fuel efficiency of 30 MPG | | and |
| | | Fuel efficiency of 20 MPG |

Which would you choose?
1 2 3 4 5 6 7 8 9

If you had a choice of car with

| A 5 speed manual transmission | | An automatic transmission |
|---|---|---|
| and | vs | and |
| Monthly payment of $500 | | Monthly payment of $300 |

Which would you choose?
1 2 3 4 5 6 7 8 9

These are examples of trade-off decisions the user may be required to make, which would allow the system to prioritize and order the importance of a range of automobile features. The configuration software may be combined with the conjoint software to assure the user that all attributes selected would be compatible in a specific automobile which is to be purchased. Without the combination of configuration and conjoint software, it would be possible for a person to order a car that does not optimize their pleasure or utility of the purchase, while all parts are compatible. It would also be possible with the conjoint system only for a person to choose an automobile that, on paper, may seem like the perfect car for them, but which would actually not work. For instance, with conjoint only, a person could choose a car with great gas mileage and a car that is very fast, while everyone knows that the faster a car is, the lower its fuel efficiency. The configuration software tells the user what is possible, while the conjoint software allows a user to optimize the user's preferences to what is possible.

### EXAMPLE 2

### Computers

Another example in which combining conjoint analysis with configuration software may be useful is in choosing a computer. The following general attributes may be considered in a combination of configuration software system and a conjoint analysis system:

how the product will be used,

parameters surrounding its use, and

product description.

Individuals usually know what a computer is and generally what type of computer they are seeking to purchase, but beyond those early descriptions and attributes, there are a number of components involved in purchasing a computer which must be compatible, while the manner in which a user intends to use the computer will have a great impact on the user's preferences. A computer cannot be built until a user describes what type of computer, data storage, memory and other features the user requires and prefers.

Examples of attributes for computer are as follow:

| | |
|---|---|
| Price | (Select a price-range category) |
| Brand of computer | (Select from Brand name categories) |
| Style of computer | (Select from Categories: Desktop, Laptop, |
| | Server, etc.) |
| Type of Display | (LCD, Monitor, Flat Screen, etc.) |
| Memory | (Select from megabyte categories) |
| Hard Drive Size | (Select from megahertz categories) |
| Hard Drive Brand | (Select from brand categories) |
| Speed | (Select from megahertz categories) |
| Network Compatible | (Yes or No) |
| Wireless capable and type | (Yes or No and Type) |
| Disk Drives | (Select from categories: floppy, CD, CDRW) |
| Weight | (Weight by categories) |
| Appearance | (Color, shape, etc.) |
| Size | (Select from dimensions in categories) |
| Operating System | (Select from list of operating systems) |
| Software | (Select types of software and brands) |
| Warranty | (Select from a category) |

Configuration software helps the user determine what is possible in the design of a computer to purchase. Configuration software is set up not to allow a user to select a system that will not be compatible with the operating system and assures a purchaser that the operating system is compatible with the software they plan to use. It can also help assure that the system has the memory and data storage size to manage the level of work for which the user plans to use the machine.

The conjoint analysis system, however, helps assure that the person selecting the computer will optimize their personal preferences for a system. By combining conjoint software with configuration software, this new software system may assure a user that the user is purchasing a computer that meets the user's technical needs, while at the same time the system will meet the user's personal preferences beyond sheer functional parameters.

Configuration attributes become attributes in a conjoint exercise. Below is an example:

Instructions for the User:

Please click on all attributes below that you believe are important in identifying and selecting a person to date: For the purpose of this example, the user selects 6 attributes from above:
1. Price
2. Memory
3. Warranty
4. Weight
5. Wireless
6. Speed
   Most users may select (click) on at least 10 attributes and, in our experience, most would select in the range of 15 attributes.

The selector tool or conjoint analysis system may then ask the user to rate (on a 1-5 or 1-9 scale) how important each attribute is to them. Based upon the attributes the user selects and the importance rating for each attribute, the conjoint system say set-up a paired-comparison trade-off exercise for each user. The pairs may be as follows:

If you had a choice of a computer that

| Is a laptop | | Is a desktop |
|---|---|---|
| That costs | vs | That costs |
| $4,000 | | $2,000 |

Which would you choose?
1 2 3 4 5 6 7 8 9

If you had a choice of a computer that

| | | |
|---|---|---|
| Is wireless compatible | | Is Not wireless compatible |
| And has | vs | And has |
| 540 Megabytes of memory | | 1 Gigabyte of memory |

Which would you choose?
1 2 3 4 5 6 7 8 9

If you had a choice of a computer with

| | | |
|---|---|---|
| A 13.5″ monitor | | A 17″ monitor |
| And | vs | And |
| 1 Gigabyte of memory | | 540 Megabytes of memory |

Which would you choose?
1 2 3 4 5 6 7 8 9

If you had a choice of a computer with

| | | |
|---|---|---|
| A 17″ monitor | | A 13.5″ monitor |
| And a | vs | And a |

| | |
|---|---|
| 1 year replacement warranty | 4 year replacement warranty |

Which would you choose?
1 2 3 4 5 6 7 8 9

As with automobiles or trucks, the configuration software only allows a user to purchase a computer with parts and components that are compatible. The conjoint engine alone would allow a user to determine what combination of product features are of highest preference, but it could allow a machine to be designed with incompatible parts. Therefore, the combination of the conjoint system with configuration software systems will assure a user that the user will optimize the user's selection from a personal preference perspective and that the system will be completely compatible in its component parts.

### EXAMPLE 3

### Building a House

Yet another example of configuration software working effectively with conjoint matching software is in the building of a house.

The following attributes may be considered in combination with a configuration software system and the conjoint preference system:

Individuals usually have a good idea of basic features in a home, but rely on architects and designers to assure that all features and equipment in the house are compatible. The combination of conjoint software to precisely determine the purchaser's desires and preferences, along with configuration software to be certain that all of these preferences are consistent with building a beautiful and highly functional house could be of great assistance to individuals, either the purchasing consumer, or the professionals who are designing, engineering, and actually constructing the house.

Beyond those early descriptions and attributes, there are a number of components involved in building a house which must be compatible, while the manner in which a purchaser intends to use the house and the purchaser's lifestyle will have a great impact on their preferences. A house cannot be built until a user describes what type of house he or she wants and rates the core features, as to importance. After this is done, using the conjoint software, the configuration software “takes charge” in order to assure that all components are compatible.

Examples of attributes for a house are as follow:

| | |
|---|---|
| Price | (Select a price-range category) |
| Size of house | (Select from list of ranges) |
| Location of house | (Select from zip code or neighborhood list) |
| Style of house | (Select from Categories: Tudor, |
| | Contemporary, etc.) |
| Number of Bedrooms | (Select a number) |
| Number of Baths | (Select a number) |
| Garage | (Yes/No and size) |
| Porches | (Yes/No, description list) |
| Pool | (Yes/No) |
| Air conditioning | (Yes/No, List of types and capacity) |
| Heat Systems | (Yes/No, list of types) |
| Energy efficiency | (Ratings and types) |

There are many more details of house design and construction which could be included in the list, but the list above represents an example of the array.

A conjoint exercise by a purchaser, first, would give the builders and architects and very robust profile of the features that the home purchaser desires in his or her new home.

The configuration software, then, would allow the builder consider the home purchaser's preference profile and design the house, with all required features and be assured that the user preferences and design features are all compatible.

Configuration attributes become attributes in a conjoint exercise. Below is an example:

Instructions for the User:

Please click on all attributes below that you believe are important in identifying and selecting a person to date: For the purpose of this example, the user selects 6 attributes from above:
1. Price
2. Size of house
3. Location of house
4. Number of bedroom
5. Number of baths
6. Heating system

It is expected that most users would select (click) on at least 10 attributes and that most would select 15 or more attributes.

The conjoint system may then ask the user to rate (on a 1-5 or 1-9 scale) how important each attribute is to the user. Based upon the attributes the user selects and the importance rating for each attribute, the conjoint system may set up a paired-comparison trade-off exercise for each user. The pairs may be as follows:

If you had a choice of a house that

| | | |
|---|---|---|
| Costs $300,000 | | Costs $400,000 |
| with | vs | with |
| gas heat | | heat pumps |

Which would you choose?
1 2 3 4 5 6 7 8 9

If you had a choice of a house that

| | | |
|---|---|---|
| Has 3 bedrooms | | Has 5 bedrooms |
| And | vs | And has |
| In the country | | In the city |

Which would you choose?
1 2 3 4 5 6 7 8 9

If you had a choice of a house with

| | | |
|---|---|---|
| A pool | | No pool |
| And | vs | And |
| No garage | | A two car garage |

Which would you choose?
1 2 3 4 5 6 7 8 9

If you had a choice of a house with

| | | |
|---|---|---|
| 3000 Sq Ft. | | 2000 Sq. Ft. |
| and a | vs | and a |
| No pool | | A Pool |

Which would you choose?
1 2 3 4 5 6 7 8 9

As with automobiles, computers, and other significantly complicated items, the configuration software only allows a user to build and purchase a house with parts and components which are compatible. The conjoint engine alone may allow a user to determine what combination of product features are of highest preference, but it could allow a house to be designed with incompatible design or engineering. Therefore, the combination of the conjoint system with configuration software systems may assure a user that the user will optimize the user's selection from a personal preference perspective and that the house will be completely compatible in its component parts.

It will be understood that various details of the subject matter described herein may be changed without departing from the scope of the subject matter described herein. Furthermore, the foregoing description is for the purpose of illustration only, and not for the purpose of limitation—the subject matter described herein being defined by the claims.

1. A method for facilitating choices among complex alternatives using conjoint analysis and at least one of psychological and skills test results, the method comprising:
(a) obtaining at least one of psychological and skills tests results for a user; and
(b) using the at least one of psychological and skills test results in combination with conjoint analysis to facilitate selection among complex alternatives, wherein using the at least one of psychological and skills test results in combination with conjoint analysis to facilitate selection among complex alternatives includes using the at least one of psychological and skills test results to select at least one of attributes presented during the conjoint analysis and results presented after the conjoint analysis.

2. The method of claim 1 wherein using the at least one of psychological and skills test results in combination with the conjoint analysis includes using the at least one of psychological and skills test results to select the attributes presented to the user during the conjoint analysis.

3. The method of claim 1 wherein using the at least one of psychological and skills test results in combination with the conjoint analysis includes using the at least one of psychological and skills test results to present final products or services to the user in order of best fit.

4. The method of claim 1 wherein the at least one of psychological and skills test results include personality test results and wherein the complex alternatives include individuals' profiles available through a computerized dating service.

5. The method of claim 1 wherein the complex alternatives includes real estate.

6. The method of claim 1 wherein the complex alternatives include consumer goods.

7. A method for facilitating user choices among complex alternatives using conjoint analysis and in combination with configuration software, the method comprising:
(a) executing configuration software allowing a user to select different elements or combinations of elements of complex alternatives to determine product or service designs from among the complex alternatives that match required configuration requirements of selected products or services;
(b) using the product or service designs derived from the configuration software to determine attributes presented to a user in a conjoint analysis relating to the complex alternatives; and
(c) performing the conjoint analysis using the selected attributes and outputting relative utilities of the complex alternatives.

8. A method for facilitating user choices among complex alternatives using conjoint analysis in combination with configuration software, the method comprising:
(a) performing conjoint analysis wherein a user selects between combinations of best and worst settings of different attributes relating to complex alternatives and calculating relative utilities of the complex alternatives;
(b) using results of the conjoint analysis to select elements of the complex alternatives to be presented to the user by configuration software based on the relative utilities; and
(c) executing the configuration software using the selected elements.

9. The method of claim 8 wherein the complex alternatives include real estate.

10. The method of claim 8 wherein the complex alternatives include consumer goods.

11. A system for facilitating choices among complex alternatives using conjoint analysis and at least one of psychological and skills test results, the system comprising:
(a) a psychological/skills test module for administering at least one of a psychological and a skills test to a user and obtaining at least one of psychological and skills test results for the user; and
(b) a selector tool for using the at least one of the psychological and skills test results in combination with conjoint analysis to facilitate selection among complex alternatives, wherein using the at least one of psychological and skills test results in combination with conjoint analysis to facilitate selection among complex alternatives includes using the at least one of psychological and skills test results to select at least one of attributes presented during the conjoint analysis and results presented after the conjoint analysis.

12. The system of claim 11 wherein the selector tool is adapted to use the at least one of psychological and skills test results to select the attributes to be presented to the user during the conjoint analysis.

13. The system of claim 11 wherein the selector tool is adapted to use the at least one psychological and skills test results to present final products for services to the user in order of best fit.

14. The system of claim 11 wherein the psychological/skills test module comprises a personality test module and wherein the complex alternatives include individuals' profiles available through a computerized dating service.

15. The system of claim 11 wherein the complex alternatives include real estate.

16. The system of claim 11 wherein the complex alternatives include consumer goods.

17. A system for facilitating choices among complex alternatives using conjoint analysis in combination with configuration software, the system comprising:
(a) a configuration software module for allowing a user to select different elements or combinations of elements of complex alternatives to determine product or service designs from among the complex alternatives that match required configuration requirements of selected products or services; and
(b) a selector tool for using the product or service designs derived from the configuration software to determine attributes presented to a user in a conjoint analysis relating to the complex alternatives and for performing the conjoint analysis using the selected attributes and for outputting relative utilities of the complex alternatives.

18. A system for facilitating user choices among complex alternatives using conjoint analysis in combination with configuration software, the system comprising:
(a) a selector tool for performing conjoint analysis wherein a user selects between a combination of best and worst settings of different attributes relating to complex alternatives and calculating relative utilities of the complex alternatives and for using results of the conjoint analysis to select elements of the complex alternatives to be presented to the user; and
(b) a configuration software module for allowing the user to configure a product of service using the elements selected by the user using the selector tool.

19. A computer program product comprising computer-executable instructions embodied in a computer-readable medium for performing steps comprising:
(a) obtaining at least one of psychological and skills tests results for a user; and
(b) using the at least one of psychological and skills test results in combination with conjoint analysis to facilitate selection among complex alternatives, wherein using the at least one of psychological and skills test results in combination with conjoint analysis to facilitate selection among complex alternatives includes using the at least one of psychological and skills test results to select at least one of attributes presented during the conjoint analysis and results presented after the conjoint analysis.

20. A computer program product for comprising computer-executable instructions embodied in a computer-readable medium for performing steps comprising:
(a) executing configuration software allowing a user to select different elements or combinations of elements of complex alternatives to determine product or service designs from among the complex alternatives that match required configuration requirements of selected products or services;
(b) using the product or service designs derived from the configuration software to determine attributes presented to a user in a conjoint analysis relating to the complex alternatives; and
(c) performing the conjoint analysis using the selected attributes and outputting relative utilities of the complex alternatives.

21. A computer program product comprising computer-executable instructions embodied in a computer-readable medium for performing steps comprising:
(a) performing conjoint analysis wherein a user selects between combinations of best and worst settings of different attributes relating to complex alternatives and calculating relative utilities of the complex alternatives;
(b) using results of the conjoint analysis to select elements of the complex alternatives to be presented to the user by configuration software based on the relative utilities; and
(c) executing the configuration software using the selected elements.
